(19) United States
(12) Patent Application Publication
(10) Pub. No.: US 2026/0304213 A1
(43) Pub. Date: Oct. 1, 2026

(54) REPORTING OF AVAILABLE DATA RATES FOR GUARANTEED BIT RATE QUALITY OF SERVICE FLOWS

(71) Applicant: QUALCOMM Incorporated, San Diego, CA (US)

(72) Inventors: Mickaël MONDET, Louannec (FR); Prasada Veera Reddy KADIRI, San Diego, CA (US); Sebastian SPEICHER, Wallisellen (CH)

(21) Appl. No.: 19/574,108

(22) Filed: Mar. 20, 2026

Related U.S. Application Data
(60) Provisional application No. 63/777,354, filed on Mar. 25, 2025.

(51) Int. Cl. H04W 28/02

(52) U.S. Cl. CPC H04W 28/0268

(57) ABSTRACT

This disclosure provides methods, components, devices and systems for reporting of available data rates for guaranteed bit rate (GBR) quality of service (QoS) flows. For example, a session management function (SMF) of a core network (CN) may transmit, to a centralized unit-control plane (CU-CP) associated with a first network entity, a control message including zero or more of a “Downlink Available Data Rate Request” information element (IE) that activates or deactivates reporting of the downlink available data rate and an “Uplink Available Data Rate Request” IE that activates or deactivates reporting of the uplink available data rate. Additionally, a CU-user plane (CU-UP) associated with the first network entity may transmit, to a user plane function (UPF) of the CN, a frame including a “Downlink Available Data Rate Report” IE indicating the downlink available data rate, an “Uplink Available Data Rate Report” IE indicating the uplink available data rate, or both.

### CROSS REFERENCES

This Patent Application claims the benefit of U.S. Provisional Patent Application No. 63/777,354 by MONDET et al., entitled “REPORTING OF AVAILABLE DATA RATES FOR GUARANTEED BIT RATE QUALITY OF SERVICE FLOWS,” filed Mar 25, 2025, assigned to the assignee hereof, and expressly incorporated by reference herein.

### INTRODUCTION

This disclosure relates generally to wireless communication, and more specifically to systems, devices, methods, and techniques associated with reporting of one or more available data rates.

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a centralized unit (CU) associated with a first network entity is described. The method may include obtaining, from a session management function (SMF) of a core network (CN), a first control message indicative of whether data rate reporting is activated or deactivated for uplink communications, for downlink communications, or for both the uplink communications and the downlink communications and outputting, to a user plane function (UPF) of the CN, a first frame indicative of an uplink data rate, a downlink data rate, or both, in accordance with the first control message.

An apparatus for wireless communication at a CU associated with a first network entity is described. The apparatus may include one or more memories storing processor-executable code and one or more processors coupled with the one or more memories. The one or more processors may individually or collectively be operable to execute the code to cause the CU associated with the first network entity to obtain, from an SMF of a CN, a first control message indicative of whether data rate reporting is activated or deactivated for uplink communications, for downlink communications, or for both the uplink communications and the downlink communications and output, to a UPF of the CN, a first frame indicative of an uplink data rate, a downlink data rate, or both, in accordance with the first control message.

An apparatus for wireless communication at a CU associated with a first network entity is described. The apparatus may include one or more memories and one or more processors coupled with the one or more memories. The one or more processors may be configured to cause the CU associated with the first network entity to obtain, from an SMF of a CN, a first control message indicative of whether data rate reporting is activated or deactivated for uplink communications, for downlink communications, or for both the uplink communications and the downlink communications and output, to a UPF of the CN, a first frame indicative of an uplink data rate, a downlink data rate, or both, in accordance with the first control message.

A CU associated with a first network entity for wireless communications is described. The CU associated with the first network entity may include a processing system that includes processor circuitry and memory circuitry that stores code. The processing system may be configured to cause the CU associated with the first network entity to obtain, from an SMF of a CN, a first control message indicative of whether data rate reporting is activated or deactivated for uplink communications, for downlink communications, or for both the uplink communications and the downlink communications and output, to a UPF of the CN, a first frame indicative of an uplink data rate, a downlink data rate, or both, in accordance with the first control message.

Another CU associated with a first network entity for wireless communications is described. The CU associated with a first network entity may include means for obtaining, from an SMF of a CN, a first control message indicative of whether data rate reporting is activated or deactivated for uplink communications, for downlink communications, or for both the uplink communications and the downlink communications and means for outputting, to a UPF of the CN, a first frame indicative of an uplink data rate, a downlink data rate, or both, in accordance with the first control message.

A non-transitory computer-readable medium storing code for wireless communications is described. The code may include instructions executable by one or more processors to obtain, from an SMF of a CN, a first control message indicative of whether data rate reporting is activated or deactivated for uplink communications, for downlink communications, or for both the uplink communications and the downlink communications and output, to a UPF of the CN, a first frame indicative of an uplink data rate, a downlink data rate, or both, in accordance with the first control message.

In some examples of the method, CUs, and non-transitory computer-readable medium described herein, the first frame includes a first information element indicative of whether data reporting may be activated or deactivated for the uplink communications, a second information element indicative of whether data rate reporting may be activated or deactivated for the downlink communications, or both.

In some examples of the method, CUs, apparatus, and non-transitory computer-readable medium described herein, each of the first information element and the second information element include one or more bits.

In some examples of the method, CUs, apparatus, and non-transitory computer-readable medium described herein, a first value of the one or more bits indicates the data rate reporting may be deactivated.

In some examples of the method, CUs, apparatus, and non-transitory computer-readable medium described herein, a second value of the one or more bits indicates the data rate reporting may be activated.

In some examples of the method, CUs, apparatus, and non-transitory computer-readable medium described herein, an absence of the first information element in the first control message indicates no change to the data rate reporting for the uplink communications.

In some examples of the method, CUs, apparatus, and non-transitory computer-readable medium described herein, an absence of the second information element in the first control message indicates no change to the data rate reporting for the downlink communications.

In some examples of the method, CUs, apparatus, and non-transitory computer-readable medium described herein, the first frame includes a packet data unit (PDU) session resource setup request, a PDU session resource modify request, a path switch request acknowledgment, or any combination thereof.

In some examples of the method, CUs, apparatus, and non-transitory computer-readable medium described herein, the first frame includes GBR QoS information that indicates whether the data rate reporting may be activated or deactivated for the uplink communications, for the downlink communications, or for both the uplink communications and the downlink communications.

Some examples of the method, CUs, apparatus, and non-transitory computer-readable medium described herein may further include operations, features, means, or instructions for communicating a second control message indicative of whether the data rate reporting may be activated or deactivated for the uplink communications, for the downlink communications, or for both the uplink communications and the downlink communications, based on reception of the first control message.

In some examples of the method, CUs, apparatus, and non-transitory computer-readable medium described herein, the CU may be associated with a control plane (CP) and a user plane (UP) and the second control message may be communicated from the CP to the UP.

In some examples of the method, CUs, apparatus, and non-transitory computer-readable medium described herein, the second control message includes a bearer context setup request, a bearer context modification request, or both.

In some examples of the method, CUs, apparatus, and non-transitory computer-readable medium described herein, the second control message includes GBR QoS information that indicates whether the data rate reporting may be activated or deactivated for the uplink communications, for the downlink communications, or for both the uplink communications and the downlink communications.

In some examples of the method, CUs, apparatus, and non-transitory computer-readable medium described herein, the uplink data rate, the downlink data rate, or both, may be measured by a UP at the CU.

In some examples of the method, CUs, apparatus, and non-transitory computer-readable medium described herein, the CU may be a first CU and the method, apparatuses, and non-transitory computer-readable medium may include further operations, features, means, or instructions for outputting, to a second CU associated with a second network entity, a second control message indicative of whether the data rate reporting may be activated or deactivated for the uplink communications, for the downlink communications, or for both the uplink communications and the downlink communications, based on reception of the first control message.

In some examples of the method, CUs, apparatus, and non-transitory computer-readable medium described herein, the second control message includes a handover request, a retrieve UE context response, a secondary node addition request, a secondary node modification request, or any combination thereof.

In some examples of the method, CUs, apparatus, and non-transitory computer-readable medium described herein, the second control message includes GBR QoS information that indicates whether the data rate reporting may be activated or deactivated for the uplink communications, for the downlink communications, or for both the uplink communications and the downlink communications.

In some examples of the method, CUs, apparatus, and non-transitory computer-readable medium described herein, the first network entity may be a master network entity and the second network entity may be a secondary network entity.

Some examples of the method, CUs, apparatus, and non-transitory computer-readable medium described herein may further include operations, features, means, or instructions for obtaining, from the second CU associated with the second network entity, a second frame indicative of the uplink data rate, the downlink data rate, or both, in accordance with the second control message, where transmission of the first frame may be based on reception of the second frame.

In some examples of the method, CUs, apparatus, and non-transitory computer-readable medium described herein, the second frame includes a first information element indicative of the uplink data rate, a second information element indicative of the downlink data rate, or both.

In some examples of the method, CUs, apparatus, and non-transitory computer-readable medium described herein, each of the first information element and the second information element include a bit rate information element indicative of a respective data rate.

In some examples of the method, CUs, apparatus, and non-transitory computer-readable medium described herein, the bit rate information element may be associated with a fixed length.

In some examples of the method, CUs, apparatus, and non-transitory computer-readable medium described herein, each of the first information element and the second information element include a bit rate information element indicative of a respective data rate.

In some examples of the method, CUs, apparatus, and non-transitory computer-readable medium described herein, the bit rate information element may be associated with a variable length.

In some examples of the method, CUs, apparatus, and non-transitory computer-readable medium described herein, the second frame includes a third information element indicative of a length of the first information element indicative of the uplink data rate.

In some examples of the method, CUs, apparatus, and non-transitory computer-readable medium described herein, the second frame includes a fourth information element indicative of a length of the second information element indicative of the downlink data rate.

In some examples of the method, CUs, apparatus, and non-transitory computer-readable medium described herein, each of the first information element and the second information element include a bit rate information element indicative of a respective data rate relative to a respective threshold data rate.

In some examples of the method, CUs, and non-transitory computer-readable medium described herein, the second network entity hosts a packet data convergence protocol (PDCP) entity and the second frame includes an assistance information data frame that indicates the uplink data rate, the downlink data rate, or both.

In some examples of the method, CUs, apparatus, and non-transitory computer-readable medium described herein, the second frame includes a first indicator that signals a presence of the uplink data rate in the second frame, a second indicator that signals a presence of the downlink data rate in the second frame, or both.

Some examples of the method, CUs, apparatus, and non-transitory computer-readable medium described herein may further include operations, features, means, or instructions for outputting, to a distributed unit (DU) associated with the first network entity, a second control message indicative of whether the data rate reporting may be activated or deactivated for the uplink communications, for the downlink communications, or for both the uplink communications and the downlink communications, based on reception of the first control message and obtaining, from the DU, a second frame indicative of the uplink data rate, the downlink data rate, or both, in accordance with the second control message, where transmission of the first frame may be based on reception of the second frame.

In some examples of the method, CUs, apparatus, and non-transitory computer-readable medium described herein, the second control message includes a UE context setup request, a UE context modification request, or both.

In some examples of the method, CUs, apparatus, and non-transitory computer-readable medium described herein, the second control message GBR QoS information that indicates whether the data rate reporting may be activated or deactivated for the uplink communications, for the downlink communications, or for both the uplink communications and the downlink communications.

In some examples of the method, CUs, apparatus, and non-transitory computer-readable medium described herein, the uplink data rate, the downlink data rate, or both, may be measured by the DU.

In some examples of the method, CUs, apparatus, and non-transitory computer-readable medium described herein, the first frame includes a first information element indicative of the uplink data rate, a second information element indicative of the downlink data rate, or both.

In some examples of the method, CUs, apparatus, and non-transitory computer-readable medium described herein, each of the first information element and the second information element include a bit rate information element indicative of a respective data rate.

In some examples of the method, CUs, apparatus, and non-transitory computer-readable medium described herein, the bit rate information element may be associated with a fixed length.

In some examples of the method, CUs, apparatus, and non-transitory computer-readable medium described herein, each of the first information element and the second information element include a bit rate information element indicative of a respective data rate.

In some examples of the method, CUs, apparatus, and non-transitory computer-readable medium described herein, the bit rate information element may be associated with a variable length.

In some examples of the method, CUs, apparatus, and non-transitory computer-readable medium described herein, the first frame includes a third information element indicative of a length of the first information element indicative of the uplink data rate.

In some examples of the method, CUs, apparatus, and non-transitory computer-readable medium described herein, the first frame includes a fourth information element indicative of a length of the second information element indicative of the downlink data rate.

In some examples of the method, CUs, apparatus, and non-transitory computer-readable medium described herein, each of the first information element and the second information element include a bit rate information element indicative of a respective data rate relative to a respective threshold data rate.

In some examples of the method, CUs, apparatus, and non-transitory computer-readable medium described herein, the first frame includes an uplink PDU session information frame that indicates the uplink data rate, the downlink data rate, or both.

In some examples of the method, CUs, apparatus, and non-transitory computer-readable medium described herein, the first frame includes a first indicator that signals a presence of the uplink data rate in the first frame, a second indicator that signals a presence of the downlink data rate in the first frame, or both.

In some examples of the method, CUs, apparatus, and non-transitory computer-readable medium described herein, the first frame includes a first information element indicative of whether data reporting is activated or deactivated for the uplink communications, indicative of whether data rate reporting is activated or deactivated for the downlink communications, or both.

In some examples of the method, CUs, apparatus, and non-transitory computer-readable medium described herein, the first information element includes one or more bits, where a first value of the one or more bits indicates the data rate reporting is deactivated or a second value of the one or more bits indicates the data rate reporting is activated.

In some examples of the method, CUs, apparatus, and non-transitory computer-readable medium described herein, an absence of the first information element in the first control message indicates no change to the data rate reporting for the uplink communications, the downlink communications, or both.

Some examples of the method, CUs, apparatus, and non-transitory computer-readable medium described herein may further include operations, features, means, or instructions for communicating a second control message indicative of whether the data rate reporting is activated or deactivated for the uplink communications, for the downlink communications, or for both the uplink communications and the downlink communications, based on reception of the first control message.

In some examples of the method, CUs, apparatus, and non-transitory computer-readable medium described herein, the second control message includes one of a bearer context setup request or a bearer context modification request.

In some examples of the method, CUs, apparatus, and non-transitory computer-readable medium described herein, the CU is a first CU, and some examples of the method, CUs, apparatus, and non-transitory computer-readable medium described herein may further include operations, features, means, or instructions for outputting, to a second CU associated with a second network entity, a second control message indicative of whether the data rate reporting is activated or deactivated for the uplink communications, for the downlink communications, or for both the uplink communications and the downlink communications, based on reception of the first control message.

Some examples of the method, CUs, apparatus, and non-transitory computer-readable medium described herein may further include operations, features, means, or instructions for obtaining, from the second CU associated with the second network entity, a second frame indicative of the uplink data rate, the downlink data rate, or both, in accordance with the second control message, where transmission of the first frame is based on reception of the second frame.

In some examples of the method, CUs, apparatus, and non-transitory computer-readable medium described herein, the second frame includes a first information element comprising a first bit information element indicative of the uplink data rate, a second information element comprising a second bit information element indicative of the downlink data rate, or both.

In some examples of the method, CUs, apparatus, and non-transitory computer-readable medium described herein, the first frame includes a first information element including a first bit rate information element indicative of the uplink data rate, a second information element including a second bit rate information element indicative of the downlink data rate, or both.

A method for wireless communications by a CN is described. The method may include outputting, via a SMF of the CN to a CU, a first control message indicative of whether data rate reporting is activated or deactivated for uplink communications, for downlink communications, or for both the uplink communications and the downlink communications and obtaining, from the CU via a UPF of the CN, a first frame indicative of an uplink data rate, a downlink data rate, or both, in accordance with the first control message.

An apparatus for wireless communication at a CN is described. The apparatus may include one or more memories storing processor-executable code and one or more processors coupled with the one or more memories. The one or more processors may individually or collectively be operable to execute the code to cause the CN to output, via a SMF of the CN to a CU, a first control message indicative of whether data rate reporting is activated or deactivated for uplink communications, for downlink communications, or for both the uplink communications and the downlink communications and obtain, from the CU via a UPF of the CN, a first frame indicative of an uplink data rate, a downlink data rate, or both, in accordance with the first control message.

A CN for wireless communications is described. The CN may include one or more memories and one or more processors coupled with the one or more memories. The one or more processors may be configured to cause the CU to output, via a SMF of the CN to a CU, a first control message indicative of whether data rate reporting is activated or deactivated for uplink communications, for downlink communications, or for both the uplink communications and the downlink communications and obtain, from the CU via a UPF of the CN, a first frame indicative of an uplink data rate, a downlink data rate, or both, in accordance with the first control message.

A CN for wireless communications is described. The CN may include one or more memories storing processor executable code, and one or more processors coupled with the one or more memories. The one or more processors may individually or collectively be operable to execute the code to cause the CN to output, via a SMF of the CN to a CU, a first control message indicative of whether data rate reporting is activated or deactivated for uplink communications, for downlink communications, or for both the uplink communications and the downlink communications and obtain, from the CU via a UPF of the CN, a first frame indicative of an uplink data rate, a downlink data rate, or both, in accordance with the first control message.

Another CN for wireless communications is described. The CN may include means for outputting, via a SMF of the CN to a CU, a first control message indicative of whether data rate reporting is activated or deactivated for uplink communications, for downlink communications, or for both the uplink communications and the downlink communications and means for obtaining, from the CU via a UPF of the CN, a first frame indicative of an uplink data rate, a downlink data rate, or both, in accordance with the first control message.

A non-transitory computer-readable medium storing code for wireless communications is described. The code may include instructions executable by one or more processors to output, via a SMF of the CN to a CU, a first control message indicative of whether data rate reporting is activated or deactivated for uplink communications, for downlink communications, or for both the uplink communications and the downlink communications and obtain, from the CU via a UPF of the CN, a first frame indicative of an uplink data rate, a downlink data rate, or both, in accordance with the first control message.

In some examples of the method, CNs, apparatus, and non-transitory computer-readable medium described herein, the first control message includes a first information element indicative of whether data reporting may be activated or deactivated for the uplink communications, a second information element indicative of whether data rate reporting may be activated or deactivated for the downlink communications, or both.

In some examples of the method, CNs, apparatus, and non-transitory computer-readable medium described herein, each of the first information element and the second information element include one or more bits.

In some examples of the method, CNs, apparatus, and non-transitory computer-readable medium described herein, a first value of the one or more bits indicates the data rate reporting may be deactivated.

In some examples of the method, CNs, apparatus, and non-transitory computer-readable medium described herein, a second value of the one or more bits indicates the data rate reporting may be activated.

In some examples of the method, CNs, apparatus, and non-transitory computer-readable medium described herein, an absence of the first information element in the first control message indicates no change to the data rate reporting for the uplink communications.

In some examples of the method, CNs, apparatus, and non-transitory computer-readable medium described herein, an absence of the second information element in the first control message indicates no change to the data rate reporting for the downlink communications.

In some examples of the method, CNs, apparatus, and non-transitory computer-readable medium described herein, the first control message includes a PDU session resource setup request, a PDU session resource modify request, a path switch request acknowledgment, or any combination thereof.

In some examples of the method, CNs, apparatus, and non-transitory computer-readable medium described herein, the first control message includes GBR QoS information that indicates whether the data rate reporting may be activated or deactivated for the uplink communications, for the downlink communications, or for both the uplink communications and the downlink communications.

In some examples of the method, CNs, apparatus, and non-transitory computer-readable medium described herein, the first frame includes a first information element indicative of the uplink data rate, a second information element indicative of the downlink data rate, or both.

In some examples of the method, CNs, apparatus, and non-transitory computer-readable medium described herein, each of the first information element and the second information element include a bit rate information element indicative of a respective data rate.

In some examples of the method, CNs, apparatus, and non-transitory computer-readable medium described herein, the bit rate information element may be associated with a fixed length.

In some examples of the method, CNs, apparatus, and non-transitory computer-readable medium described herein, each of the first information element and the second information element include a bit rate information element indicative of a respective data rate.

In some examples of the method, CNs, apparatus, and non-transitory computer-readable medium described herein, the bit rate information element may be associated with a variable length.

In some examples of the method, CNs, apparatus, and non-transitory computer-readable medium described herein, the first frame includes a third information element indicative of a length of the first information element indicative of the uplink data rate.

In some examples of the method, CNs, apparatus, and non-transitory computer-readable medium described herein, the first frame includes a fourth information element indicative of a length of the second information element indicative of the downlink data rate.

In some examples of the method, CNs, apparatus, and non-transitory computer-readable medium described herein, each of the first information element and the second information element include a bit rate information element indicative of a respective data rate relative to a respective threshold data rate.

In some examples of the method, CNs, apparatus, and non-transitory computer-readable medium described herein, the first frame includes an uplink PDU session information frame that indicates the uplink data rate, the downlink data rate, or both.

In some examples of the method, CNs, apparatus, and non-transitory computer-readable medium described herein, the first frame includes a first indicator that signals a presence of the uplink data rate in the first frame, a second indicator that signals a presence of the downlink data rate in the first frame, or both.

A method for wireless communications by a DU associated with a first network entity is described. The method may include obtaining, from a CU associated with the first network entity, a first control message indicative of whether data rate reporting is activated or deactivated for uplink communications, for downlink communications, or for both the uplink communications and the downlink communications and outputting, to the CU, a first frame indicative of an uplink data rate, a downlink data rate, or both, in accordance with the first control message.

An apparatus for wireless communication at a DU associated with a first network entity described. The apparatus may include one or more memories storing processor executable code, and one or more processors coupled with the one or more memories. The one or more processors may individually or collectively be operable to execute the code to cause the DU associated with the first network entity to obtain, from a CU associated with the first network entity, a first control message indicative of whether data rate reporting is activated or deactivated for uplink communications, for downlink communications, or for both the uplink communications and the downlink communications and output, to the CU, a first frame indicative of an uplink data rate, a downlink data rate, or both, in accordance with the first control message.

An apparatus for wireless communication at a DU associated with a first network entity is described. The apparatus may include one or more memories and one or more processors coupled with the one or more memories. The one or more processors may be configured to cause the DU associated with the first network entity to obtain, from a CU associated with the first network entity, a first control message indicative of whether data rate reporting is activated or deactivated for uplink communications, for downlink communications, or for both the uplink communications and the downlink communications and output, to the CU, a first frame indicative of an uplink data rate, a downlink data rate, or both, in accordance with the first control message.

A DU associated with a first network entity for wireless communications is described. The DU associated with the first network entity may include a processing system that includes processor circuitry and memory circuitry that stores code. The processing system may be configured to cause the DU associated with the first network entity to obtain, from a CU associated with the first network entity, a first control message indicative of whether data rate reporting is activated or deactivated for uplink communications, for downlink communications, or for both the uplink communications and the downlink communications and output, to the CU, a first frame indicative of an uplink data rate, a downlink data rate, or both, in accordance with the first control message.

Another DU associated with a first network entity for wireless communications is described. The DU associated with the first network entity may include means for obtaining, from a CU associated with the first network entity, a first control message indicative of whether data rate reporting is activated or deactivated for uplink communications, for downlink communications, or for both the uplink communications and the downlink communications and means for outputting, to the CU, a first frame indicative of an uplink data rate, a downlink data rate, or both, in accordance with the first control message.

A non-transitory computer-readable medium storing code for wireless communications is described. The code may include instructions executable by one or more processors to obtain, from a CU associated with the first network entity, a first control message indicative of whether data rate reporting is activated or deactivated for uplink communications, for downlink communications, or for both the uplink communications and the downlink communications and output, to the CU, a first frame indicative of an uplink data rate, a downlink data rate, or both, in accordance with the first control message.

In some examples of the method, DUs, apparatus, and non-transitory computer-readable medium described herein, the first control message includes a UE context setup request, a UE context modification request, or both.

In some examples of the method, DUs, apparatus, and non-transitory computer-readable medium described herein, the first control message includes GBR QoS information that indicates whether the data rate reporting may be activated or deactivated for the uplink communications, for the downlink communications, or for both the uplink communications and the downlink communications.

In some examples of the method, DUs, apparatus, and non-transitory computer-readable medium described herein, the uplink data rate, the downlink data rate, or both, may be measured by the DU.

### BRIEF DESCRIPTION OF THE DRAWINGS

FIG. 1 shows an example of a wireless communication system in accordance with one or more aspects of the present disclosure.

FIG. 2 shows an example of a signaling diagram that supports reporting of available data rates for guaranteed bit rate (GBR) quality of service (QoS) flows in accordance with one or more aspects of the present disclosure.

FIG. 3 shows an example of a process flow that supports reporting of available data rates for GBR QoS flows in accordance with one or more aspects of the present disclosure.

FIG. 4 shows a block diagram of a processing system that supports reporting of available data rates for GBR QoS flows in accordance with one or more aspects of the present disclosure.

FIG. 5 shows a diagram of a system including a device that supports reporting of available data rates for GBR QoS flows in accordance with one or more aspects of the present disclosure.

FIGS. 6 through 8 show flowcharts illustrating methods that support reporting of available data rates for GBR QoS flows in accordance with one or more aspects of the present disclosure.

FIGS. 9 shows a diagram of a system including a device that supports reporting of available data rates for GBR QoS flows in accordance with one or more aspects of the present disclosure.

FIGS. 10 shows an example of a network architecture that supports reporting of available data rates for GBR QoS flows in accordance with one or more aspects of the present disclosure.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communications systems may support communications, applications, services, or the like thereof, associated with a guaranteed bit rate (GBR) quality of service (QoS) flows. A GBR QoS flow may be a flow of traffic (e.g., video, voice, etc.) that is associated with a threshold (e.g., minimum) data rate, where the threshold data rate is based on a QoS to be provided by the communications, applications, services, or the like. For example, for video streaming, a network entity (e.g., including a distributed unit (DU) and a centralized unit (CU)) may transmit a flow of video stream data to a UE in accordance with a GBR to support minimal buffering (e.g., buffering below a threshold quantity of buffering) of a video stream, where the flow of video stream data communicated in accordance with the GBR may be a type of GBR QoS flow. However, in some cases, a core network (CN) (e.g., 5th generate core (5GC)) associated with the network entity (e.g., the RAN node including the DU and the CU) may not be aware of one or more available data rates (e.g., a first threshold, or maximum, data rate that can be supported by an uplink communication link, a second threshold, or maximum, data rate that can be supported by a downlink communication link) associated with a communication link between the network entity and the UE, such that the CN may allocate resources for a GBR QoS flow that result in degraded user experience (e.g., a degraded QoS). That is, without knowledge of the available data rate, the CN may allocate resources for a GBR QoS flow in accordance with a data rate (e.g., bits/second, kilobits/second, megabits/second, gigabits/second), which may be referred to as an allocated data rate, that is either too high (e.g., higher than an available data rate), resulting in dropped packets, or too low (e.g., lower than the available data rate), resulting in inefficient resource utilization (e.g., a higher rate could be used than is configured). When the allocated data rate (e.g., allocated by the CN) is too high (e.g., higher than an available data rate), the dropped packets may further result in decreased communication performance and, in some cases, failure of communications. When the allocated data rate (e.g., allocated by the CN) is too low (e.g., lower than the available data rate), the inefficient resource utilization may result in sub-optimal communication performance (e.g., due to the allocated data rate being slower than the available data rate). As described herein, an allocated data rate may refer to a date rate allocated, or configured by the CN and an available data (e.g., downlink available data rate, uplink available data rate) rate may refer to a data rate (e.g., maximum data rate) supported by a communication link (e.g., downlink communication link, uplink communication link, respectively), between the network entity (e.g., RAN node) and a UE, for a GBR QoS flow.

Accordingly, aspects of the subject matter described in this disclosure relate to available data rate reporting between various aspects of a network entity and a CN. The data rates that are reported may include an uplink available data rate that is from a UE to a network entity, a downlink available data rate that is from a network entity to a UE, or both (e.g., for configuration of GBR QoS flows), associated with a GBR QoS flow. For example, a session management function (SMF) of a CN may transmit (e.g., output), to a centralized unit-control plane (CU-CP) associated with a first network entity (e.g., cell, network node), a control message that includes, optionally, a “Downlink Available Data Rate Request” information element (IE) that activates or deactivates reporting of the downlink available data rate associated with the GBR QoS flow and an “Uplink Available Data Rate Request” IE that activates (e.g., enable, initiate, start) or deactivates (e.g., disable, suspend, stop) reporting of the uplink available data rate associated with the GBR QoS flow. In such case, an absence of the Downlink Available Data Rate Request IE, an absence of the Uplink Available Data Rate Request IE, or both, in the control message may indicate no change to corresponding available data rate reporting. Conversely, when the Downlink Available Data Rate Request IE is present in the control message, the Downlink Available Data Rate Request IE may include one or more first bits, where a first value (e.g., 0) of the one or more first bits may correspond to a request to deactivate available data rate reporting for downlink communications (e.g., downlink available data rate reporting) and a second value (e.g., 1) of the one or more first bits may correspond to a request to activate available data rate reporting for downlink communications. Additionally, or alternatively, when the Uplink Available Data Rate Request IE is present in the control message, the Uplink Available Data Rate Request IE may include one or more second bits, where a first value (e.g., 0) of the one or second more bits may correspond to a request to deactivate available data rate reporting for uplink communications (e.g., uplink available data rate reporting) and a second value (e.g., 1) of the one or more second bits may correspond to a request to activate available data rate reporting for uplink communications.

In some cases, measurement of the uplink available data rate, the downlink available data rate, or both, associated with the GBR QoS flow, may be performed by a CU-user plane (CU-UP) associated with the first network entity (e.g., a first cell, a first network node, a first base station). In such cases, after receiving the uplink available data rate request, the downlink available data rate request, or both, from the SMF, the CU-CP may forward the uplink available data rate request, the downlink available data rate request, or both, respectively, to the CU-UP. Additionally, the CU-UP may measure the uplink available data rate, the downlink available data rate, or both, associated with the GBR QoS flow. Further, the CU-UP may transmit (e.g., via a frame) an indication of the uplink available data rate, the downlink available data rate, or both, to a UPF of the CN.

In some other cases, measurement of the uplink available data rate, the downlink available data rate, or both, associated with the GBR QoS flow, may be performed by a DU associated with the first network entity (e.g., the first cell, the first network node, the first base station). In such cases, after receiving the uplink available data rate request, the downlink available data rate request, or both, from the SMF, the CU-CP may forward the uplink available data rate request, the downlink available data rate request, or both, respectively, to the DU associated with the first network entity. Additionally, the DU may measure the uplink available data rate, the downlink available data rate, or both, associated with the GBR QoS flow. Further, the DU may transmit (e.g., via a frame) an indication of the uplink available data rate, the downlink available data rate, or both, to the CU-UP. The CU-UP may then forward the indication to the UPF of the CN.

Additionally, or alternatively, the CU-CP may forward the uplink available data rate request, the downlink available data rate request, or both (e.g., in accordance with the control message associated with the GBR QoS flow), to a CU of a second network entity. For example, the second network entity may be a target network entity, such that the CU-CP (e.g., associated with the first network entity) may forward the uplink available data rate request, the downlink available data rate request, or both, to the CU of the second network entity as part of a handover procedure. In some other examples, the CU-CP may forward the uplink available data rate request, the downlink available data rate request, or both (e.g., in accordance with the control message), to the CU of the second network entity based on the first network entity being a master network entity (e.g., master node (MN)) and the second network entity being a secondary network entity (e.g., secondary node (SN)), in accordance with a dual-connectivity configuration.

Additionally, or alternatively, the indication of the uplink available data rate, the downlink available data rate, or both, may be via one or more additional IEs. For example, the CU-UP may output (e.g., transmit), to a user plane function (UPF) at the CN, a frame (e.g., data frame of a User Plane protocol) including a “Downlink Available Data Rate Report” IE indicating the downlink available data rate, an “Uplink Available Data Rate Report” IE indicating the uplink available data rate, or both. In some cases, the Downlink Available Data Rate Report IE may indicate a value of the downlink available data rate and the Uplink Available Data Rate Report IE may indicate a value of the uplink available data rate. In such cases, a length of (e.g., a quantity of bits in) each IE may be fixed in accordance with a respective threshold (e.g., maximum) value of each available data rate, or may be variable in accordance with a respective value of each available data rate. In some other cases, the Downlink Available Data Rate Report IE may indicate a first percentage of a threshold (e.g., maximum) value of the downlink available data rate (e.g., as configured by the CN) and the Uplink Available Data Rate Report IE may indicate a second percentage of a threshold (e.g., maximum) value of the uplink available data rate (e.g., as configured by the CN). That is, the first percentage may indicate the value of the downlink available data rate relative to the threshold (e.g., maximum) value of the downlink available data rate and the second percentage may indicate the value of the uplink available data rate relative to the threshold (e.g., maximum) value of the uplink available data rate.

In some examples, by reporting the uplink available data rate, the downlink available data rate, or both, the described techniques can be used to configure one or more GBR QoS flows in accordance with the uplink available data rate, the downlink available data rate, or both (e.g., perform rate adaption in accordance with the one or more available data rates). Configuring the one or more GBR QoS flows in accordance with the uplink available data rate, the downlink available data rate, or both, may further result in increased communication performance and decreased signaling overhead due to a reduction in dropped or discarded packets. For example, when the CN is aware of the available data rate, the CN may allocate resources in accordance with the available data rate, thus avoiding dropped or discarded packets. Additionally, or alternatively, configuring the one or more GBR QoS flows in accordance with the uplink available data rate, the downlink available data rate, or both, may result in more efficient resource utilization and increased communication performance. For example, when the CN is aware of the available data rate, the CN may allocate resources in accordance with the available data rate, thus achieving a threshold (e.g., maximum, optimal) level of communication performance.

While described in the context of GBR QoS flows, this is not intended to be a limitation of the present disclosure. In this regard, any type of QoS flow may be considered with regards to the techniques described herein.

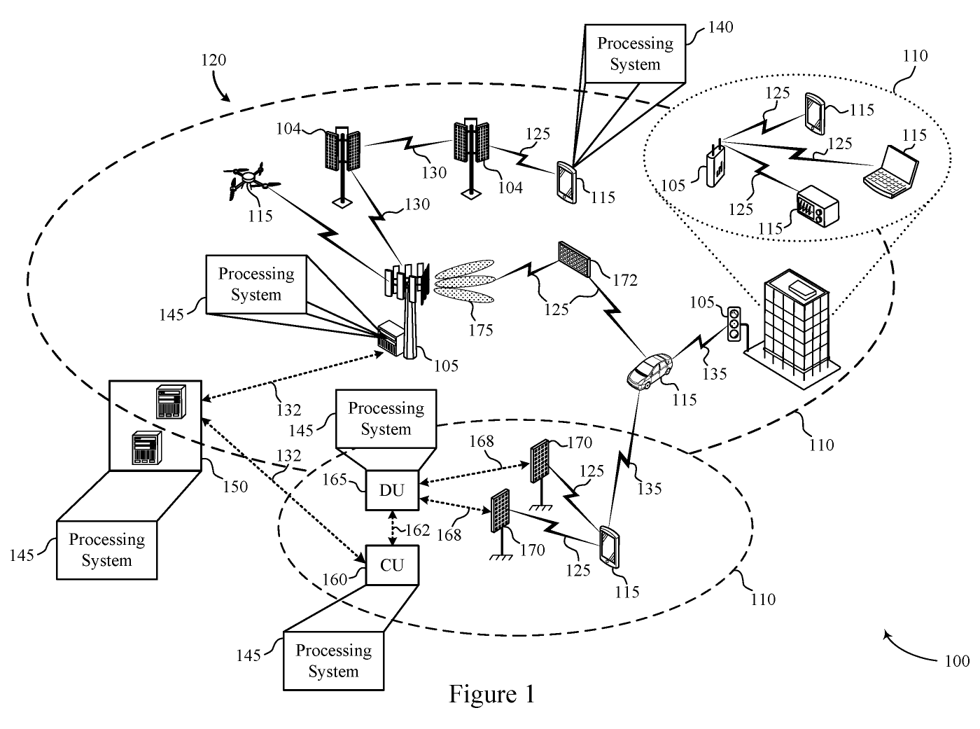

FIG. 1 shows an example of a wireless communication system 100. The wireless communication system 100 includes a CN 150 and a RAN 120 that support communication with one or more devices, such as UEs 115, in accordance with one or more aspects of the present disclosure. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a CN 150, supporting radio bearers for user plane data. A Physical (PHY) layer may map transport channels to physical channels.

A CN 150 may support user authentication, access authorization, tracking, IP connectivity, and other access, routing, or mobility functions (such as via network entities 105). A CN 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a UPF).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a CU (such as CU 160), a DU (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

Techniques described herein, in addition to or as an alternative to be carried out between UEs 115 and base stations 105, may be implemented via additional or alternative wireless devices, including IAB nodes 104, distributed units (DUs) 165, centralized units (CUs) 160, radio units (RUs) 170, and the like. For example, in some implementations, aspects described herein may be implemented in the context of a disaggregated radio access network (RAN) architecture (e.g., open RAN architecture). In a disaggregated architecture, the RAN may be split into three areas of functionality corresponding to the CU 160, the DU 165, and the RU 170. The split of functionality between the CU 160, DU 165, and RU 170 is flexible and as such gives rise to numerous permutations of different functionalities depending upon which functions (e.g., MAC functions, baseband functions, radio frequency functions, and any combinations thereof) are performed at the CU 160, DU 165, and RU 170. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communication system 100), infrastructure and spectral resources for NR access may additionally support wireless backhaul link capabilities in supplement to wireline backhaul connections, providing an IAB network architecture. One or more base stations 105 may include CUs 160, DUs 165, and RUs 170 and may be referred to as donor base stations 105 or IAB donors. One or more DUs 165 (e.g., and/or RUs 170) associated with a donor base station 105 may be partially controlled by CUs 160 associated with the donor base station 105. The one or more donor base stations 105 (e.g., IAB donors) may be in communication with one or more additional base stations 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communication system 100 may include a CN 150 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of base stations 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the CN 150 and the AN (e.g., via a wireline or wireless connection to the CN 150). That is, an IAB donor may refer to a RAN node with a wireline or wireless connection to CN 150. The IAB donor may include a CU 160 and at least one DU 165 (e.g., and RU 170), where the CU 160 may communicate with the CN 150 over an NG interface (e.g., some backhaul link). The CU 160 may host layer 3 (L3) (e.g., RRC, service data adaption protocol (SDAP), PDCP, etc.) functionality and signaling. The at least one DU 165 and/or RU 170 may host lower layer, such as layer 1 (L1) and layer 2 (L2) (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a base station 105 may additionally, or alternatively, be performed by components of the disaggregated RAN architecture (e.g., IAB nodes, DUs, CUs, etc.).

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a CN 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a CN 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The electromagnetic spectrum is often subdivided, based on frequency/wavelength, into various classes, bands, channels, etc. In 5G NR two initial operating bands have been identified as frequency range designations FR1 (410 MHz – 7.125 GHz) and FR2 (24.25 GHz – 52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz – 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz – 24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4–1 (52.6 GHz – 71 GHz), FR4 (52.6 GHz – 114.25 GHz), and FR5 (114.25 GHz – 300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4–1, and/or FR5, or may be within the EHF band.

Devices of the wireless communication system 100 may be configured to support one or more aspects of the described techniques for reporting of available data rates for GBR QoS flows. For example, a UE 115 may include a processing system 140, and a network entity 105 (e.g., a CU 160, a DU 165, a CN 150) may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support available data rate reporting of an uplink available data rate, a downlink available data rate, or both, per GBR QoS flow for use by a CN in configuration of one or more GBR QoS data flows.

For example, an SMF of a CN may transmit, to a CU-CP associated with a first network entity, a control message including zero or more of a Downlink Available Data Rate Request IE that activates or deactivates reporting of the downlink available data rate per GBR QoS flow and an Uplink Available Data Rate Request IE that activates or deactivates reporting of the uplink available data rate per GBR QoS flow. That is, the control message may include a Downlink Available Data Rate Request IE per GBR QoS flow that activates or deactivates reporting of the downlink available data rate for a respective GBR QoS flow, an Uplink Available Data Rate Request’ IE per GBR QoS flow that activates or deactivates reporting of the uplink available data rate for a respective GBR QoS flow, or both. Additionally, a CU-UP associated with the first network entity may transmit, to a UPF of the CN, a frame including a Downlink Available Data Rate Report IE indicating the downlink available data rate associated with a GBR QoS flow, an Uplink Available Data Rate Report IE indicating the uplink available data rate associated with the GBR QoS flow, or both. In such cases, the frame including the Downlink Available Data Rate Report’ IE indicating the downlink available data rate associated with the GBR QoS flow, the ‘Uplink Available Data Rate Report’ IE indicating the uplink available data rate associated with the GBR QoS flow, or both, may be transmitted by the CU-UP via a transport tunnel associated with the GBR QoS flow. Thus, when receiving the frame, the UPF may identify which GBR QoS flow the Downlink Available Data Rate Report’ IE, the ‘Uplink Available Data Rate Report’ IE, or both, corresponds to based on the transport tunnel used to communicate the frame.

By reporting the uplink available data rate, the downlink available data rate, or both, the described techniques can be used to configure one or more GBR QoS flows in accordance with the uplink available data rate, the downlink available data rate, or both (e.g., perform rate adaption in accordance with the uplink available data rate, the downlink available data rate, or both). Configuring the one or more GBR QoS flows in accordance with the uplink available data rate, the downlink available data rate, or both, may further result in increased communication performance and decreased signaling overhead due to a reduction in dropped or discarded packets. For example, as described herein, when the CN allocates resources for a GBR QoS flow in accordance with an allocated data rate that is greater than an available data rate, one or more packets may be dropped or discarded. However, when the CN is aware of the available data rate, the CN may allocate resources in accordance with the available data rate, thus avoiding dropped or discarded packets.

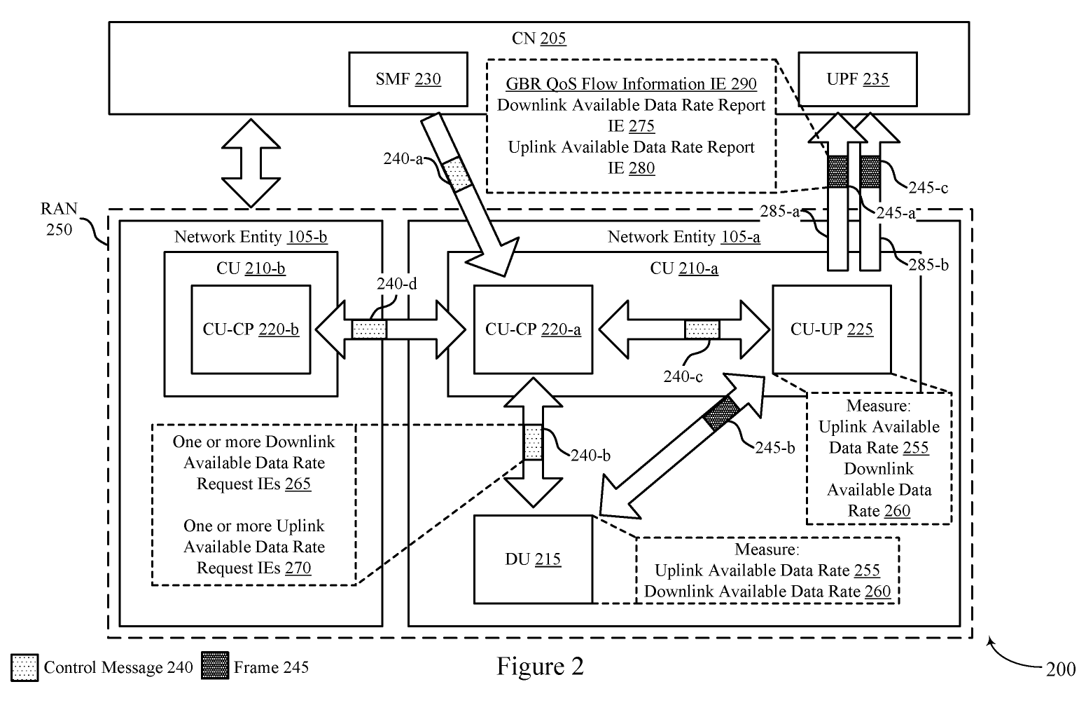

FIG. 2 shows an example of a signaling diagram 200 that supports reporting of available data rates for GBR QoS flows in accordance with one or more aspects of the present disclosure. In some cases, the signaling diagram 200 may implement or be implemented by aspects of the wireless communication system 100. For example, the signaling diagram 200 may include one or more network entities 105 (e.g., a network entity 105-a and a network entity 105-b), which may be examples of the corresponding devices as described herein.

Some wireless communications systems mays support communications, applications, services, or the like thereof, associated with GBR QoS flows. That is, a GBR QoS flow may be a flow of traffic (e.g., video, voice, etc.) that is associated with a threshold (e.g., minimum) data rate, where the threshold data rate is based on a QoS to be provided by the communications, applications, services, or the like thereof. For example, for video streaming, a network entity 105 may transmit a flow of video stream data to a UE in accordance with a GBR to support minimal buffering (e.g., buffering below a threshold quantity of buffering) of a video stream, where the flow of video stream data communicated in accordance with the GBR may be referred to as a GBR QoS flow.

However, in some cases, a CN 205 (e.g., 5GC) associated with the network entity 105 may not be aware of one or more available data rates (e.g., threshold data rates, supported data rates) associated with a communication link between the network entity and the UE, such that the CN 205 may allocate resources for a GBR QoS flow that result in degraded user experience (e.g., a degraded QoS). That is, the CN 205 may allocate resources to the network entity 105 for a GBR QoS flow and, in some cases, the CN 205 may allocate resources in accordance with one or more allocated data rates that are greater than the one or more available data rates, result in decreased communication performance and, in some cases, failure of communications due to dropped or discarded packets. In some other cases, the CN 205 may allocate resources in accordance with one or more allocated data rates that are less than the one or more available data rates, resulting in inefficient resource utilization and sub-optimal communication performance (e.g., communication performance less than can be achieved by the one or more available data rates).

Accordingly, techniques described herein may support activation or deactivation of available data rate reporting, as well as the available data rate reporting of an uplink available data rate 255 (e.g., available data rate in uplink), a downlink available data rate 260 (e.g., available data rate in downlink), or both (e.g., associated with a GBR QoS flow 285). In particular, techniques described herein may support a CN 205 (e.g., 5GC) configuring a RAN 250 with one or more GBR QoS flows 285 for which the RAN 250 is request to report the uplink available data rate 255, the downlink available data rate 260, or both, may support a CU-CP 220-a associated with a network entity 105-a configuring a CU-UP 225 associated with the network entity 105-a or a DU 215 associated with the network entity 105-a for measurement and reporting of the uplink available data rate 255, the downlink available data rate 260, or both, and may support the reporting of the uplink available data rate 255, the downlink available data rate 260, or both, to a UPF 235 of the CN 205 (e.g., through a UP). As described herein, reporting of the uplink available data rate 255, the downlink available data rate 260, or both, may collectively be referred to as available data rate reporting.

For example, for a GBR QoS flow 285 (e.g., a GBR QoS flow 285-a, a GBR QoS flow 285-b), the CN 205 may request to activate or deactivate reporting of the uplink available data rate 255, reporting of the downlink available data rate 260, or reporting of both the uplink available data rate 255 and the downlink available data rate 260 (e.g., per GBR QoS flow 285). In some cases, a control message 240 (e.g., RRC message, DCI message, MAC-CE message) may include one or more information elements to request the activation or deactivation. For example, the control message 240 may include a Downlink Available Data Rate Request IE 265 (e.g., per GBR QoS flow 285) to activate or deactivate (e.g., request activation or deactivation of) reporting of the downlink available data rate 260, an Uplink Available Data Rate Request IE 270 (e.g., per GBR QoS flow 285) to activate or deactivate (e.g., request activation or deactivation of) reporting of the uplink available data rate 255, or both. In some cases, the control message 240 may include multiple Downlink Available Data Rate Request IEs 265, multiple Uplink Available Data Rate Request IEs 270, or both, where each Downlink Available Data Rate Request IE 265 corresponds to a respective GBR QoS flow 285, each Uplink Available Data Rate Request IE 270 corresponds to a GBR QoS flow 285, or both, respectively. In such cases, a first value (e.g., 0) of the Downlink Available Data Rate Request IE 265 may indicate a request to deactivate reporting of the downlink available data rate 260 (e.g., for a corresponding GBR QoS flow 285) and a second value (e.g., 1) of the Downlink Available Data Rate Request IE 265 may indicate a request to activate reporting of the downlink available data rate 260 (e.g., for the corresponding GBR QoS flow 285). Similarly, the first value (e.g., 0) of the Uplink Available Data Rate Request IE 270 may indicate a request to deactivate reporting of the uplink available data rate 255 (e.g., for a corresponding GBR QoS flow 285) and a second value (e.g., 1) of the Uplink Available Data Rate Request IE 270 may indicate a request to activate reporting of the uplink available data rate 255 (e.g., for the corresponding GBR QoS flow 285).

Conversely, absence of the Downlink Available Data Rate Request IE 265 (e.g., for a respective GBR QoS flow 285) in the control message 240 may indicate no change to reporting of the downlink available data rate 260 and absence of the Uplink Available Data Rate Request IE 270 (e.g., for a respective GBR QoS flow 285) in the control message 240 may indicate no change to reporting of the uplink available data rate 255. For example, at a first time, reporting of the downlink available data rate 260 may be activated and, at a second time after the first time, the CN 205 may transmit the control message 240 without the Downlink Available Data Rate Request IE. 265 Thus, at a third time after the second time, reporting of the downlink available data rate 260 may remain activated.

The Downlink Available Data Rate Request IE 265 and the Uplink Available Data Rate Request IE 270 may apply to (e.g., be supported by) communications between the CN 205 (e.g., an SMF 230 of the CN 205) and the CU-CP 220-a of a CU 210-a associated with the network entity 105-a (e.g., Next Generation Application Protocol (NG-AP)), communications between the CU 210-a associated with the network entity 105-a and a CU 210-b associated with a network entity 105-b (e.g., Xn Application Protocol (Xn-AP)), communications between the CU-CP 220-a and the CU-UP 225 (e.g., E1 Application Protocol (E1-AP)), communications between the CU-CP 220-a and a DU 215 of the CU 210-a (e.g., F1 Application Protocol (F1-AP)), or any combination thereof.

For example, the CN 205 (e.g., 5GC, an SMF 230) may configure the RAN 250 with available data rate reporting through one or more PDU session management messages, one or more UE mobility management messages, or both. That is, the CN 205 may transmit, to the CU-CP 220-a, a control message 240-a (e.g., NG-AP control message) including zero or more of the Uplink Available Data Rate Request IE 270 (e.g., per GBR QoS flow 285) and Downlink Available Data Rate Request IE 265 (e.g., per GBR QoS flow 285), where the control message 240-a is an NG-AP message. The NG-AP message may be a PDU session resource setup request (e.g., triggering a PDU session resource setup response), a PDU session resource modify request (e.g., triggering a PDU session resource modify response), a path switch request acknowledgment (e.g., in response to a path switch request), or any combination thereof. In such cases, when the control message 240-a is an NG-AP message, the control message 240-a may include a “GBR QoS Flow Information” IE 290 (e.g., NG-AP IE, per GBR QoS flow) that further includes zero or more of the Uplink Available Data Rate Request IE 270 (e.g., for a respective GBR QoS flow 285) and Downlink Available Data Rate Request IE 265 (e.g., for the respective GBR QoS flow 285).

Additionally, in some cases, the CU-CP 220-a (e.g., gNB-CU-CP) may use bearer management procedures to provide the CU-UP 225 (e.g., gNB-CU-UP) with the request for available data rate reporting (e.g., received from the CN 205 via the control message 240-a). For example, the CU-CP 220-a may transmit, to the CU-UP 225, a control message 240-c (e.g., E1-AP control message) including zero or more of the Uplink Available Data Rate Request IE 270 and Downlink Available Data Rate Request IE 265 when measurement of the uplink available data rate 255, the downlink available data rate 260, or both is performed by the CU-UP 225. In such cases, the control message 240-c may be an E1-AP message, such as a bearer context setup request (e.g., triggering a bearer context setup response), a bearer context modification request (e.g., triggering a bearer context modification response), or both. A bearer context setup request may be a message used to set up a new bearer path between a UE and the network entity 105-a and may indicate one or more QoS parameters, a bearer type, an IP address, traffic routing information, a bearer context identifier, or any combination thereof. Similarly, a bearer context modification request may be a message used to modify an already established bearer path between the UE and the network entity 105-a and may indicate one or more modified QoS parameters, a modified bearer type, a change in traffic routing information, or any combination thereof. In such cases, when the control message 240-c is an E1-AP message, the control message 240-c may include a GBR QoS Flow Information IE 290 (e.g., E1-AP IE, per GBR QoS flow 285) that further includes zero or more of the Uplink Available Data Rate Request IE 270 (e.g., for a respective GBR QoS flow 285) and Downlink Available Data Rate Request IE 265 (e.g., for the respective GBR QoS flow 285).

Additionally, or alternatively, the CU-CP 220-a may use user context management procedures to provide the DU 215 (e.g., gNB-DU) with the request for available data rate reporting (e.g., received from the CN 205 via the control message 240-a). For example, the CU-CP 220-a may transmit, to the DU 215, a control message 240-b (e.g., F1-AP control message) including zero or more of the Uplink Available Data Rate Request IE 270 and Downlink Available Data Rate Request IE 265 when measurement of the uplink available data rate 255, the downlink available data rate 260, or both is performed by the DU 215. In such cases, the control message 240-b may be an F1-AP message, such as a UE context setup request (e.g., triggering a UE context setup response), a UE context modification request (e.g., triggering a UE context modification response), or both. A UE context setup request may be a message communicated when a UE first attaches to the network entity 105-a or when a new session for the UE is created and may indicate UE identity information, bearer context information, security information, an IP address allocation, access network information, or any combination thereof. Similarly, a UE context setup request may be a message communicated when a change in context of the UE occurs, such as due to changes in a network, service thresholds, or user mobility, and may indicate updated bearer context information, UE mobility information, updated security information, a change in IP address, one or more modified QoS parameters, or any combination thereof. In such cases, when the control message 240-c is an E1-AP message, the control message 240-b may include a GBR QoS Flow Information IE 290 (e.g., F1-AP IE, per GBR QoS flow 285) that further includes zero or more of the Uplink Available Data Rate Request IE 270 (e.g., for a respective GBR QoS flow 285) and Downlink Available Data Rate Request IE 265 (e.g., for the respective GBR QoS flow 285).

Additionally, or alternatively, during an XN handover procedure, during a retrieve UE context procedure, or both, the CU-CP 220-a (e.g., source CU-CP) associated with the network entity 105-a may provide a CU-CP 220-b (e.g., of the CU 210-b) associated with the network entity 105-b with the request for available data rate reporting (e.g., received from the CN 205 via the control message 240-a). For example, the CU-CP 220-a may transmit, to the CU-CP 220-b, a control message 240-d (e.g., Xn-AP control message) including zero or more of the Uplink Available Data Rate Request IE 270 and Downlink Available Data Rate Request IE 265, where the control message 240-d is an Xn-AP message. The Xn-AP message may be a handover request (e.g., triggering a handover request acknowledgment), a retrieve UE context response (e.g., in response to a retrieve UE context request), or both. In such cases, when the control message 240-d is an Xn-AP message, the control message 240-d may include a GBR QoS Flow Information IE 290 (e.g., Xn-AP IE, per GBR QoS flow 285) that further includes zero or more of the Uplink Available Data Rate Request IE 270 (e.g., for a respective GBR QoS flow 285) and Downlink Available Data Rate Request IE 265 (e.g., for the respective GBR QoS flow 285).

Additionally, or alternatively, when a UE 115 is configured with dual connectivity (DC) (e.g., configured with a first communication link with the network entity 105-a and a second communication link with the network entity 105-b), the CU-CP 220-a (e.g., master CU-CP) associated with the network entity 105-a, which may be a master node (MN) (e.g., master network entity 105), may provide the CU-CP 220-b (e.g., target CU-CP) associated with the network entity 105-b, which may be a secondary node (SN) (e.g., secondary network entity 105, S-Node), with the request for available data rate reporting (e.g., received from the CN 205 via the control message 240-a). In such cases, the control message 240-d is may be an SN addition request (e.g., triggering an SN addition request acknowledgment), an SN modification request (e.g., triggering an SN modification request acknowledgment), or both. In some examples, the CU-CP 220-a may transmit the control message 240-d based on the network entity 105-b being associated with one or more SN terminated bearers, the network entity 105-b hosting a PDCP entity, or both.

Additionally, as described herein, the network entity 105-a may report, via a frame 245, the uplink available data rate 255, the downlink available data rate 260, or both, to the CN 205 (e.g., the UPF of the CN 205) in accordance with the control message 240-a. In such cases, the network entity 105-a may transmit a frame 245 indicating one or more of an Uplink Available Data Rate Report IE 280 indicating the uplink available data rate 255 (e.g., indicating a respective uplink available data rate 255 per GBR QoS flow 285) and a Downlink Available Data Rate Report IE 275 indicating the downlink available data rate 260 (e.g., indicating a respective downlink available data rate 260 per GBR QoS flow 285). For example, the CU-UP 225 may transmit a frame 245-a via a first transport tunnel associated with the GBR QoS flow 285-a, where the frame 245-a indicates a first Downlink Available Data Rate Report IE 275, an first Uplink Available Data Rate Report IE 280, or both, associated with the GBR QoS flow 285-a. Similarly, the CU-UP 225 may transmit a frame 245-c via a second transport tunnel associated with the GBR QoS flow 285-b, where the frame 245-c indicates a second Downlink Available Data Rate Report IE 275, a second Uplink Available Data Rate Report IE 280, or both, associated with the GBR QoS flow 285-b. The Uplink Available Data Rate Report IE 280 and the Downlink Available Data Rate Report IE 275 may be referred to as the reporting IEs.

In such cases, in accordance with CP protocols (e.g., NG-AP), the CN 205 may configure one or more threshold (e.g., maximum) data rates (e.g., bit rates), such as a threshold downlink data rate, a threshold uplink data rate, or both. In some cases, the threshold downlink data rate may be the same as the threshold uplink data rate, such that a single threshold data rate is configured for both uplink and downlink. That is, the CN 205 may transmit a control message including one or more “Bit Rate” IEs that indicates a quantity of bits delivered by the RAN 250 in uplink (e.g., the threshold uplink data rate) or to the RAN 250 in downlink (e.g., the threshold downlink data rate) within a period of time, divided by a duration of the period. In such cases, the one or more Bit Rate IEs may be used to indicate a threshold (e.g., maximum) or GBR for a GBR QoS flow 285, or an aggregate threshold bit rate. Thus, as the reported available date rates (e.g., the uplink available data rate 255, the downlink available data rate 260, or both) may reach the one or more threshold data rates configured by the CN 205, the network entity 105-a may support one or more options for reporting the available data rates (e.g., one or more definitions of the reporting IEs).

In some cases (e.g., Option 1), the reporting IEs may be defined as the Bit Rate IE of the CP protocols with a fixed length. That is, each of the Uplink Available Data Rate Report IE 280 and the Downlink Available Data Rate Report IE 275 may be associated with a fixed length, where the fixed length is based on the one or more threshold data rates configured by the CN 205. For example, the fixed length may be 6 bytes, which may be associated with carrying a threshold value of the Bit Rate IE (e.g., 4000000000000 bit/s). That is, the threshold value of the Bit Rate IE may correspond to a threshold value of the uplink available data rate 255 and the downlink available data rate 260, such that each of the Uplink Available Data Rate Report IE 280 and the Downlink Available Data Rate Report IE 275 may be of the fixed length to enable reporting of up to the threshold value of the uplink available data rate 255 and the downlink available data rate 260.

Additionally, or alternatively, (e.g., Option 2), the reporting IEs may be defined with a variable length that corresponds to a quantity of bytes associated with carrying a value of the Bit Rate IE configured by the CN 205. That is, a first length of the Uplink Available Data Rate Report IE 280 may be based on a first value of the uplink available data rate 255 (e.g., a first quantity of bytes required to indicate the first value via the Uplink Available Data Rate Report IE 280) and a second length of the Downlink Available Data Rate Report IE 275 may be based on a second value of the downlink available data rate 260 (e.g., a second quantity of bytes required to indicate the second value via the Downlink Available Data Rate Report IE 275). In such cases, the frame 245 may additionally include an “Uplink Available Data Rate Report Length” IE indicating the first length of the Uplink Available Data Rate Report IE 280 and a “Downlink Available Data Rate Report” Length IE indicating the second length of the Downlink Available Data Rate Report IE 275.

Additionally, or alternatively, (e.g., Option 3), the reporting IEs may be defined as a percentage (e.g., of a value of the one or more threshold data rates configured by the CN 205) with a value range of [0 . . . 100]. That is, each available data rate may be reported as a percentage of a value of a respective threshold data rate (e.g., of the Bit Rate IE). For example, a first percentage indicated via the Uplink Available Data Rate Report IE 280 may be based on (e.g., equal to) the first value of the uplink available data rate 255 relative to the threshold uplink data rate and a second percentage indicated via the Downlink Available Data Rate Report IE 275 may be based on (e.g., equal to) the second value of the downlink available data rate 260 relative to the threshold downlink data rate. In such cases, a length of each of the Uplink Available Data Rate Report IE 280 and the Downlink Available Data Rate Report IE 275 may be equal to 1 byte.

In some cases, the RAN 250 (e.g., the CU-UP 225) may report the uplink available data rate 255, the downlink available data rate 260, or both (e.g., for one or more GBR QoS flows), to the UPF of the CN 205 (e.g., in accordance with the control message 240-a) via a frame 245-a, where the frame 245-a is an uplink PDU session information frame of a PDU Session User Plane protocol. That is, the uplink PDU session information frame may include one or more of the Uplink Available Data Rate Report IE 280 and the Downlink Available Data Rate Report IE 275. In such cases, the inclusion of one or more of the Uplink Available Data Rate Report IE 280 and the Downlink Available Data Rate Report IE 275 in the uplink PDU session information frame may be optional, such that a presence of each of the Uplink Available Data Rate Report IE 280 and the Downlink Available Data Rate Report IE 275 may be signaled via a respective IE. For example, the uplink PDU session information frame may include an “Uplink Available Data Rate Report Indicator” IE indicting a presence of the Uplink Available Data Rate Report IE 280 in the uplink PDU session information frame, may include a “Downlink Available Data Rate Report” Indicator IE indicting a presence of the Downlink Available Data Rate Report IE 275 in the uplink PDU session information frame, or both. Additionally, as discussed above, the uplink PDU session information frame (e.g., frame 245-a) may include an Uplink Available Data Rate Report Length IE indicating the first length of the Uplink Available Data Rate Report IE 280 and a Downlink Available Data Rate Report Length IE indicating the second length of the Downlink Available Data Rate Report IE 275. In some cases, when the DU 215 measures the uplink available data rate 255, the downlink available data rate 260, or both, the DU 215 may transmit a frame 245-b (e.g., or another type of signaling) to the CU-UP 225 indicating the uplink available data rate 255, the downlink available data rate 260, or both, for forwarding to the UPF 235.

In some cases (e.g., not depicted), as described herein, the network entity 105-b may host the PDCP entity, such that the network entity 105-a may report the uplink available data rate 255, the downlink available data rate 260, or both (e.g., for one or more GBR QoS flows) to the network entity 105-b based on the network entity 105-b hosting the PDCP entity. In such cases, the network entity 105-a may report the uplink available data rate 255, the downlink available data rate 260, or both, via an assistance information data frame (e.g., of the NR UP protocol, a type of frame 245). That is, the assistance information data frame may include one or more of the Uplink Available Data Rate Report IE 280 and the Downlink Available Data Rate Report IE 275. In such cases, the inclusion of one or more of the Uplink Available Data Rate Report IE 280 and the Downlink Available Data Rate Report IE 275 in the assistance information data frame may be optional, such that a presence of each of the Uplink Available Data Rate Report IE 280 and the Downlink Available Data Rate Report IE 275 may be signaled via a respective IE. For example, the assistance information data frame may include an Uplink Available Data Rate Report Indicator IE indicting a presence of the Uplink Available Data Rate Report IE 280 in the assistance information data frame, may include a Downlink Available Data Rate Report Indicator IE indicting a presence of the Downlink Available Data Rate Report IE 275 in the assistance information data frame, or both. Additionally, as discussed above, the assistance information data frame may include an Uplink Available Data Rate Report Length IE indicating the first length of the Uplink Available Data Rate Report IE 280 and a Downlink Available Data Rate Report Length IE indicating the second length of the Downlink Available Data Rate Report IE 275. In such cases, the network entity 105-b may report the uplink available data rate 255, the downlink available data rate 260, or both, to the CN 205.

To summarize, the techniques described herein may define signaling and processes that supports the RAN 250 reporting, to the CN 205 (e.g., 5GC) an uplink available data rate 255, a downlink available data rate 260, or both, for one or more GBR QoS flows. In such cases, the signaling and processes include the CN 205 configuring the one or more GBR QoS flows for which the RAN 250 is requested to activate or deactivate available data rate reporting, the DU 215 or the CU-UP 225 measuring the uplink available data rate 255, the downlink available data rate 260, or both, and the RAN 250 (e.g., CU-UP 225) reporting, to the CN 205, the uplink available data rate 255, the downlink available data rate 260, or both, through an Uplink Available Data Rate Report IE 280, a Downlink Available Data Rate Report IE 275, or both, respectively, in an uplink PDU session information frame of a PDU session UP protocol.

As described herein, a control message 240 may include an Uplink Available Data Rate Request IE 270, a Downlink Available Data Rate Request IE 265, or both, per (e.g., associated with each) GBR QoS flow 285. That is, the control message 240 may include multiple Uplink Available Data Rate Request IEs 280, multiple Downlink Available Data Rate Request IEs 275, or both, where each Uplink Available Data Rate Request IE 270 is associated with a respective GBR QoS flow 285 and each Downlink Available Data Rate Request IE 265 is associated with a respective GBR QoS flow 285. For example, a control message 240, such as the control message 240-a, may include a first Downlink Available Data Rate Request IE 265 may be associated with the GBR QoS flow 285-a and a second Downlink Available Data Rate Request IE 265 may be associated with the GBR QoS flow 285-b.

In the case of multiple GBR QoS flows 285, the CU-UP 225 may transmit a frame 245 including an Uplink Available Data Rate Report IE 280, a Downlink Available Data Rate Report IE 275, or both, per GBR QoS flow 285. That is, the CU-UP 225 may transmit a frame 245 (e.g., including an Uplink Available Data Rate Report IE 280, a Downlink Available Data Rate Report IE 275, or both) for each GBR QoS flow 285 with available data rate reporting activated. In such cases, the CU-UP 225 may transmit a frame 245 associated with a GBR QoS flow 285 (e.g., from multiple GBR QoS flows 285) via a transport tunnel associated with the GBR QoS flow 285, such that the UPF 235 may identify which GBR QoS flow 285 (e.g., from multiple GBR QoS flows 285) the Downlink Available Data Rate Report IE 275, the Uplink Available Data Rate Report IE 280, or both, corresponds to based on the transport tunnel used to communicate the frame 245.

As described herein, a CN 205 is a central network infrastructure that provides services like mobility management, session management, and data routing between a UE 115 and one or more external networks. An SMF 230 is a component of the CN 205 that is responsible for managing user sessions, including IP address allocation, bearer management, and mobility management. A UPF 235 is a component of the CN 205 that handles user data forwarding, packet inspection, and traffic routing to and from the one or more external networks. A CU 210 is a centralized component of the RAN responsible for high-layer processing, including control plane and user plane functions. A CU-CP 220 that is a control plane component of the CU 210, responsible for signaling, mobility management, and session management functions in the RAN. A CU-CP 220 is a user plane component of the CU 210, responsible for user data forwarding and routing between the RAN and the CN 205. A DU 215 is a distributed component of the RAN, responsible for lower-layer processing, such as signal processing and radio resource management.

While described in the context of GBR QoS flows 285, this is not intended to be a limitation of the present disclosure. In this regard, any type of QoS flow may be considered with regards to the techniques described herein.

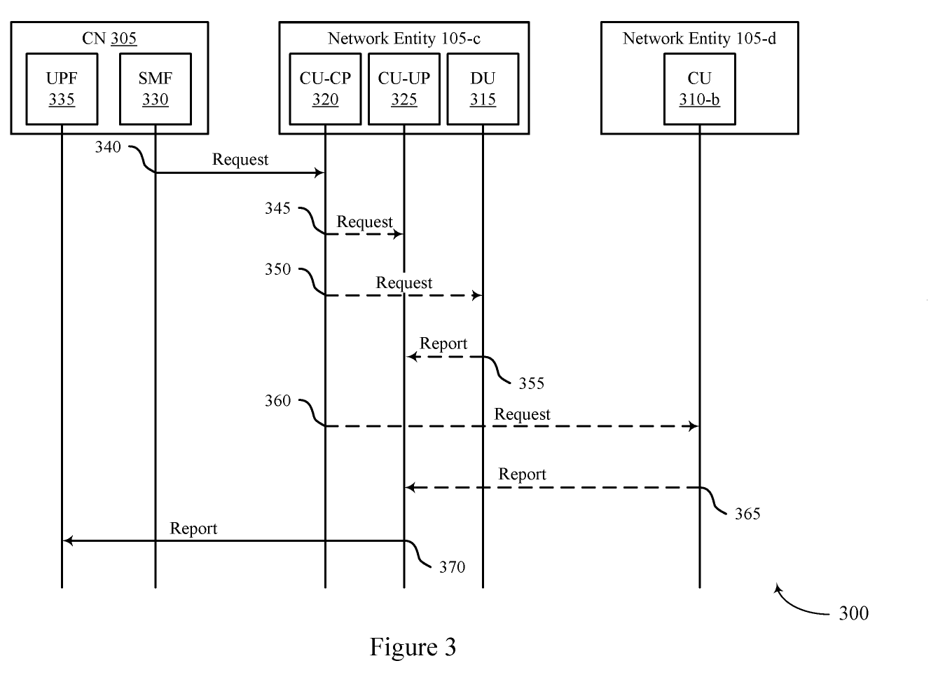

FIG. 3 shows an example of a process flow 300 that supports reporting of available data rates for GBR QoS flows in accordance with one or more aspects of the present disclosure. In some cases, the process flow 300 may implement or be implemented by aspects of the wireless communication system 100, the signaling diagram 200, or both. For example, the process flow 300 may include signaling that pertains to available data rates for communications with one or more UEs 115 (from FIG. 1) and one or more network entities 105 (from FIG. 1, e.g., a network entity 105-c and a network entity 105-d from FIG. 3), which may be examples of the corresponding devices as described herein. In the following description of the process flow 300, the operations may be communicated in a different order than the example order shown, or the operations may be performed in different orders or at different times. Some operations may also be omitted from the process flow 300, and other operations may be added to the process flow 300.

At 340, an SMF 330 of a CN 305 may output (e.g., transmit), to a CU-CP 320 of a CU 310-a (e.g., not depicted) associated with a network entity 105-c, a first control message (e.g., a control message 240, as described with reference to FIG. 2) indicative of whether data reporting (e.g., available data rate reporting) is activated or deactivated for uplink communications (e.g., an uplink available data rate), for downlink communications (e.g., a downlink available data rate), or for both the uplink communications and the downlink communications.

In such cases, the first control message may include a first IE (e.g., Uplink Available Data Rate Request IE) indicative of whether data reporting is activated or deactivated for the uplink communications (e.g., for a GBR QoS flow), a second IE (e.g., Downlink Available Data Rate Request IE) indicative of whether data rate reporting is activated or deactivated for the downlink communications (e.g., for the GBR QoS flow), or both. Each of the first IE and the second IE may include one or more bits, where a first value (e.g., 0) of the one or more bits indicates the respective data reporting is deactivated and a second value (e.g., 1) of the one or more bits indicates the respective data reporting is activated. Conversely, an absence of the first IE in the first control message may indicate no change to the data rate reporting for the uplink communications and an absence of the second IE in the first control message may indicate no change to the data rate reporting for the downlink communications.

In such cases, the first control message may be a PDU session resource setup request, a PDU session resource modify request, a path switch request, or any combination thereof. Additionally, the first control message may include a GBR QoS information IE associated with the GBR QoS flow (e.g., per GBR QoS flow) that indicates whether the data rate reporting is activated or deactivated for the uplink communications (e.g., for the GBR QoS flow), for the downlink communications (e.g., for the GBR QoS flow), or for both the uplink communications and the downlink communications (e.g., for the GBR QoS flow).

In some cases, a CU-UP 325 associated with the network entity 105-c may measure the uplink available data rate, the downlink available data rate, or both, such that, at 345, the CU-CP 320 may communicate (e.g., transmit), to the CU-UP 325, a second control message indicative of whether the data rate reporting is activated or deactivated for the uplink communications, for the downlink communications, or for both the uplink communications and the downlink communications, based on reception of the first control message. In such cases, the second control message may include a bearer context setup request, a bearer context modification request, or both. Additionally, the second control message may include a GBR QoS information IE associated with the GBR QoS flow (e.g., per GBR QoS flow) that indicates whether the data rate reporting is activated or deactivated for the uplink communications (e.g., for the GBR QoS flow), for the downlink communications (e.g., for the GBR QoS flow), or for both the uplink communications and the downlink communications (e.g., for the GBR QoS flow).

In some other cases, a DU 315 associated with the network entity 105-c may measure the uplink available data rate, the downlink available data rate, or both, such that, at 350, the CU-CP 320 may communicate (e.g., transmit), to the DU 315, a third control message indicative of whether the data rate reporting is activated or deactivated for the uplink communications, for the downlink communications, or for both the uplink communications and the downlink communications, based on reception of the first control message. The third control message may include a UE context setup request, a UE context modification request, or both. Additionally, the third control message may include a GBR QoS information IE associated with the GBR QoS flow (e.g., per GBR QoS flow) that indicates whether the data rate reporting is activated or deactivated for the uplink communications (e.g., for the GBR QoS flow), for the downlink communications (e.g., for the GBR QoS flow), or for both the uplink communications and the downlink communication (e.g., for the GBR QoS flows).

In such cases, at 355, the DU 315 may output, to the CU-UP 325, a first frame indicative of the uplink available data rate, the downlink available data rate, or both, in accordance with the third control message. In such cases, the first frame may include a third IE (e.g., Uplink Available Data Rate Report IE) indicative of the uplink available data rate, a fourth IE indicative of the downlink available data rate (e.g., Downlink Available Data Rate Report IE), or both.

Additionally, or alternatively, at 360, the CU-CP 320 associated with the network entity 105-c may output, to a CU 310-b (e.g., a CU-CP of the CU 310-b) associated with a network entity 105-d, a fourth control message indicative of whether the data rate reporting is activated or deactivated for the uplink communications, for the downlink communications, or for both the uplink communications and the downlink communications, based on reception of the first control message. In such cases, the second control message may include a handover request, a retrieve UE context response, an SN addition request, an SN modification request, or any combination thereof. Additionally, the fourth control message may include a GBR QoS information IE associated with the GBR QoS flow (e.g., per GBR QoS flow) that indicates whether the data rate reporting is activated or deactivated for the uplink communications (e.g., for the GBR QoS flow), for the downlink communications (e.g., for the GBR QoS flow), or for both the uplink communications and the downlink communications (e.g., for the GBR QoS flow). In some cases, the CU-CP 320 may output the fourth control message to the CU 310-b based on the network entity 105-c being an MN and the network entity 105-d being an SN, based on the network entity 105-d hosting a PDCP entity, or both.

In some cases, at 365, the CU-UP 325 may obtain (e.g., receive), from the CU 310-b (e.g., a CU-UP of the CU 310-b), a second frame indicative of the uplink available data rate, the downlink available data rate, or both, (e.g., associated with the GBR QoS flow) in accordance with the fourth control message. In such cases, the second frame may include the third IE (e.g., Uplink Available Data Rate Report IE) indicative of the uplink available data rate, the fourth IE indicative of the downlink available data rate (e.g., Downlink Available Data Rate Report IE), or both. In some cases, the CU-UP 325 may obtain the second frame from the CU 310-b based on the network entity 105-c hosting the PDCP entity. In such cases, the second frame may be an assistance information data frame that indicates the uplink available data rate, the downlink available data rate, or both.

In some cases, each of the third IE and the fourth IE may include a Bit Rate IE indicative of a respective available data rate, where the Bit Rate IE is associated with a fixed length. In some other cases, each of the third IE and the fourth IE may include a Bit Rate IE indicative of a respective available data rate, where the Bit Rate IE is associated with a variable length. In such cases, the second frame may additionally include a fifth IE (e.g., Uplink Available Data Rate Report Length IE) indicative of a length of the third IE and a sixth IE (e.g., Downlink Available Data Rate Report Length IE) indicative of a length of the fourth IE. In some other cases, each of the third IE and the fourth IE may include a Bit Rate IE indicative of a respective available data rate, where the Bit Rate IE indicates a respective available data rate relative to a respective threshold available data rate.

In some cases, the second frame may additionally include a first indicator (e.g., ‘Uplink Available Data Rate Report Indicator’ IE) that signals a presence of the uplink available data rate in the second frame, a second indicator that signals a presence of the downlink available data rate in the second frame indicator (e.g., ‘Downlink Available Data Rate Report Indicator’ IE), or both.

At 370, the CU-UP 325 of the first CU associated with the network entity 105-c may output, to a UPF 335 of the CN 305, a third frame (e.g., a frame 245, as described with reference to FIG. 2) indictive of the uplink available data rate, the downlink available data rate, or both, (e.g., associated with the GBR QoS flow) in accordance with the first control message. In such cases, the third frame may include the third IE (e.g., Uplink Available Data Rate Report IE) indicative of the uplink available data rate, the fourth IE indicative of the downlink available data rate (e.g., Downlink Available Data Rate Report IE), or both.

As described herein, each of the third IE and the fourth IE may include a Bit Rate IE indicative of a respective available data rate, where the Bit Rate IE is associated with a fixed length. In some other cases, each of the third IE and the fourth IE may include a Bit Rate IE indicative of a respective available data rate, where the Bit Rate IE is associated with a variable length. In such cases, the third frame may additionally include a fifth IE (e.g., Uplink Available Data Rate Report Length IE) indicative of a length of the third IE and a sixth IE (e.g., Downlink Available Data Rate Report Length IE) indicative of a length of the fourth IE. In some other cases, each of the third IE and the fourth IE may include a Bit Rate IE indicative of a respective available data rate, where the Bit Rate IE indicates a respective available data rate relative to a respective threshold available data rate.

In some cases, the third frame may additionally include the first indicator (e.g., ‘Uplink Available Data Rate Report Indicator’ IE) that signals a presence of the uplink available data rate in the third frame, the second indicator that signals a presence of the downlink available data rate in the third frame indicator (e.g., ‘Downlink Available Data Rate Report Indicator’ IE), or both.

Though described in the context of a single GBR QoS flow, this is not to be regarded as a limitation of the present disclosure. In this regard, a control message (e.g., the first control message, the second control message, the third control message, the fourth control message) may include a first IE (e.g., Uplink Available Data Rate Request IE), a second IE (e.g., Downlink Available Data Rate Request IE), or both, per (e.g., associated with each) GBR QoS flow. That is, the control message may include multiple first IEs, multiple second IEs, or both, where each first IE and each second IE is associated with a respective GBR QoS flow.

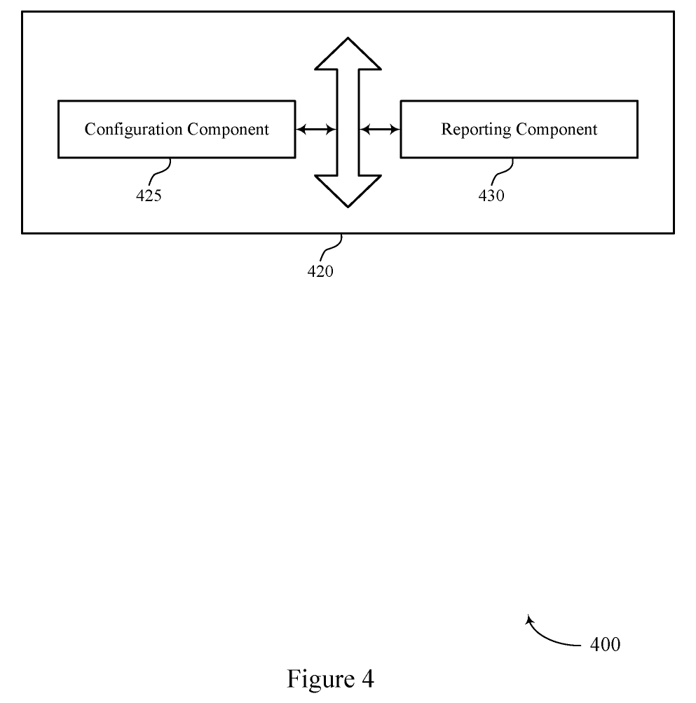

FIG. 4 shows an example of a processing system 420 that supports reporting of available data rates for GBR QoS flows in accordance with one or more aspects of the present disclosure. A processing system 420 may be an example of a processing system 145 (such as network entity 105) and may include a configuration component 425 a reporting component 430, or any combination thereof. A processing system 420, or various component thereof, may be an example of means for performing (such as a means for causing a network entity 105 to perform) various techniques described herein.

The configuration component 425 may be configured to cause the network entity 105 to obtain, from an SMF of a CN, a first control message indicative of whether data rate reporting is activated or deactivated for uplink communications, for downlink communications, or for both the uplink communications and the downlink communications. The reporting component 430 may be configured to cause the network entity 105 to output, to a UPF of the CN, a first frame indicative of an uplink data rate, a downlink data rate, or both, in accordance with the first control message.

In some examples, the first frame includes a first information element indicative of whether data reporting is activated or deactivated for the uplink communications, a second information element indicative of whether data rate reporting is activated or deactivated for the downlink communications, or both.

In some examples, each of the first information element and the second information element include one or more bits.

In some examples, a first value of the one or more bits indicates the data rate reporting is deactivated.

In some examples, a second value of the one or more bits indicates the data rate reporting is activated.

In some examples, an absence of the first information element in the first control message indicates no change to the data rate reporting for the uplink communications.

In some examples, an absence of the second information element in the first control message indicates no change to the data rate reporting for the downlink communications.

In some examples, the first control message includes a PDU session resource setup request, a PDU session resource modify request, a path switch request acknowledgment, or any combination thereof.

In some examples, the first control message includes GBR QoS information that indicates whether the data rate reporting is activated or deactivated for the uplink communications, for the downlink communications, or for both the uplink communications and the downlink communications.

In some examples, the configuration component 425 may be configured to cause the network entity 105 to communicate a second control message indicative of whether the data rate reporting is activated or deactivated for the uplink communications, for the downlink communications, or for both the uplink communications and the downlink communications, based on reception of the first control message.

In some examples, the CU is associated with a CP and a UP. In some examples, the second control message is communicated from the CP to the UP.

In some examples, the second control message includes a bearer context setup request, a bearer context modification request, or both.

In some examples, the second control message includes GBR QoS information that indicates whether the data rate reporting is activated or deactivated for the uplink communications, for the downlink communications, or for both the uplink communications and the downlink communications.

In some examples, the uplink data rate, the downlink data rate, or both, are measured by a UP at the CU.

In some examples, the CU is a first CU, and the configuration component 425 may be configured to cause the network entity 105 to output, to a second CU associated with a second network entity, a second control message indicative of whether the data rate reporting is activated or deactivated for the uplink communications, for the downlink communications, or for both the uplink communications and the downlink communications, based on reception of the first control message.

In some examples, the second control message includes a handover request, a retrieve UE context response, a secondary node addition request, a secondary node modification request, or any combination thereof.

In some examples, the second control message includes GBR QoS information that indicates whether the data rate reporting is activated or deactivated for the uplink communications, for the downlink communications, or for both the uplink communications and the downlink communications.

In some examples, the first network entity is a master network entity. In some examples, the second network entity is a secondary network entity.

In some examples, the reporting component 430 may be configured to cause the network entity 105 to obtain, from the second CU associated with the second network entity, a second frame indicative of the uplink data rate, the downlink data rate, or both, in accordance with the second control message, where transmission of the first frame is based on reception of the second frame.

In some examples, the second frame includes a first information element indicative of the uplink data rate, a second information element indicative of the downlink data rate, or both.

In some examples, each of the first information element and the second information element include a bit rate information element indicative of a respective data rate.

In some examples, the bit rate information element is associated with a fixed length.

In some examples, each of the first information element and the second information element include a bit rate information element indicative of a respective data rate.

In some examples, the bit rate information element is associated with a variable length.

In some examples, the second frame includes a third information element indicative of a length of the first information element indicative of the uplink data rate.

In some examples, the second frame includes a fourth information element indicative of a length of the second information element indicative of the downlink data rate.

In some examples, each of the first information element and the second information element include a bit rate information element indicative of a respective data rate relative to a respective threshold data rate.

In some examples, the second network entity hosts a packet data convergence protocol (PDCP) entity. In some examples, the second frame includes an assistance information data frame that indicates the uplink data rate, the downlink data rate, or both.

In some examples, the second frame includes a first indicator that signals a presence of the uplink data rate in the second frame, a second indicator that signals a presence of the downlink data rate in the second frame, or both.

In some examples, the configuration component 425 may be configured to cause the network entity 105 to output, to a DU associated with the first network entity, a second control message indicative of whether the data rate reporting is activated or deactivated for the uplink communications, for the downlink communications, or for both the uplink communications and the downlink communications, based on reception of the first control message. In some examples, the reporting component 430 may be configured to cause the network entity 105 to obtain, from the DU, a second frame indicative of the uplink data rate, the downlink data rate, or both, in accordance with the second control message, where transmission of the first frame is based on reception of the second frame.

In some examples, the second control message includes a UE context setup request, a UE context modification request, or both.

In some examples, the second control message includes GBR QoS information that indicates whether the data rate reporting is activated or deactivated for the uplink communications, for the downlink communications, or for both the uplink communications and the downlink communications.

In some examples, the uplink data rate, the downlink data rate, or both, are measured by the DU.

In some examples, the first frame includes a first information element indicative of the uplink data rate, a second information element indicative of the downlink data rate, or both.

In some examples, each of the first information element and the second information element include a bit rate information element indicative of a respective data rate.

In some examples, the bit rate information element is associated with a fixed length.

In some examples, each of the first information element and the second information element include a bit rate information element indicative of a respective data rate.

In some examples, the bit rate information element is associated with a variable length.

In some examples, the first frame includes a third information element indicative of a length of the first information element indicative of the uplink data rate.

In some examples, the first frame includes a fourth information element indicative of a length of the second information element indicative of the downlink data rate.

In some examples, each of the first information element and the second information element include a bit rate information element indicative of a respective data rate relative to a respective threshold data rate.

In some examples, the first frame includes an uplink PDU session information frame that indicates the uplink data rate, the downlink data rate, or both.

In some examples, the first frame includes a first indicator that signals a presence of the uplink data rate in the first frame, a second indicator that signals a presence of the downlink data rate in the first frame, or both.

In some examples, the configuration component 425 may be configured to cause the network entity 105 to output, via an SMF of the CN to a CU, a first control message indicative of whether data rate reporting is activated or deactivated for uplink communications, for downlink communications, or for both the uplink communications and the downlink communications. In some examples, the reporting component 430 may be configured to cause the network entity 105 to obtain, from the CU via a UPF of the CN, a first frame indicative of an uplink data rate, a downlink data rate, or both, in accordance with the first control message.

In some examples, the first control message includes a first information element indicative of whether data reporting is activated or deactivated for the uplink communications, a second information element indicative of whether data rate reporting is activated or deactivated for the downlink communications, or both.

In some examples, each of the first information element and the second information element include one or more bits.

In some examples, a first value of the one or more bits indicates the data rate reporting is deactivated.

In some examples, a second value of the one or more bits indicates the data rate reporting is activated.

In some examples, an absence of the first information element in the first control message indicates no change to the data rate reporting for the uplink communications.

In some examples, an absence of the second information element in the first control message indicates no change to the data rate reporting for the downlink communications.

In some examples, the first control message includes a PDU session resource setup request, a PDU session resource modify request, a path switch request acknowledgment, or any combination thereof.

In some examples, the first control message includes GBR QoS information that indicates whether the data rate reporting is activated or deactivated for the uplink communications, for the downlink communications, or for both the uplink communications and the downlink communications.

In some examples, the first frame includes a first information element indicative of the uplink data rate, a second information element indicative of the downlink data rate, or both.

In some examples, each of the first information element and the second information element include a bit rate information element indicative of a respective data rate.

In some examples, the bit rate information element is associated with a fixed length.

In some examples, each of the first information element and the second information element include a bit rate information element indicative of a respective data rate.

In some examples, the bit rate information element is associated with a variable length.

In some examples, the first frame includes a third information element indicative of a length of the first information element indicative of the uplink data rate.

In some examples, the first frame includes a fourth information element indicative of a length of the second information element indicative of the downlink data rate.

In some examples, each of the first information element and the second information element include a bit rate information element indicative of a respective data rate relative to a respective threshold data rate.

In some examples, the first frame includes an uplink PDU session information frame that indicates the uplink data rate, the downlink data rate, or both.

In some examples, the first frame includes a first indicator that signals a presence of the uplink data rate in the first frame, a second indicator that signals a presence of the downlink data rate in the first frame, or both.

In some examples, the configuration component 425 may be configured to cause the network entity 105 to obtain, from a CU associated with the first network entity, a first control message indicative of whether data rate reporting is activated or deactivated for uplink communications, for downlink communications, or for both the uplink communications and the downlink communications. In some examples, the reporting component 430 may be configured to cause the network entity 105 to output, to the CU, a first frame indicative of an uplink data rate, a downlink data rate, or both, in accordance with the first control message.

In some examples, the first control message includes a UE context setup request, a UE context modification request, or both.

In some examples, the first control message includes GBR QoS information that indicates whether the data rate reporting is activated or deactivated for the uplink communications, for the downlink communications, or for both the uplink communications and the downlink communications.

In some examples, the uplink data rate, the downlink data rate, or both, are measured by the DU.

A processing system 420 may include or be an example of one or more chips, SoCs, chipsets, packages, components, or devices that individually or collectively constitute or include a processing system. A processing system 420 may interface with other components of a network entity 105. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a network entity 105). Operations described herein with reference to the processing system 420, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 420 for operation in a processing system 420 as described herein, the processing system 420 may support techniques for activating or deactivating reporting of an available uplink data rate, reporting of an available downlink data rate, or reporting of both the uplink data rate and the downlink data rate, as well as the reporting of the uplink data rate, the downlink data rate, or both, which may result in reduced processing, reduced power consumption, and more efficient utilization of communication resources, among other advantage.

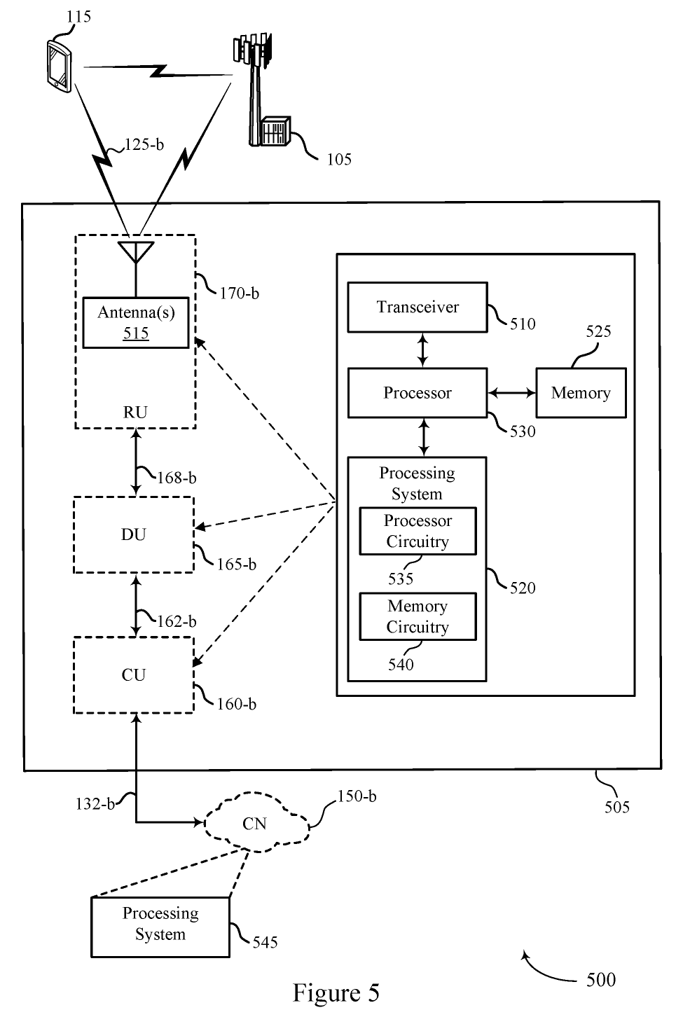

FIG. 5 shows an example of a system 500 including a device 505 that supports reporting of available data rates for GBR QoS flows in accordance with one or more aspects of the present disclosure. The device 505 may communicate (such as via one or more wired interfaces or one or more wireless interfaces) with other network devices or network equipment such as a CN 150-b (e.g., associated with a processing system 545), other network entities 105, UEs 115, or any combination thereof. The device 505 may include components for transmitting and receiving communication, which may include a processing system 520, a transceiver 510, antenna(s) 515, a memory 525, and a processor 530. Components of the device 505 may be coupled (such as operatively, communicatively, functionally, electronically, electrically, in electronic communication) via one or more interfaces.

The transceiver 510 may communicate bi-directionally with another transceiver via wired or wireless links, and may support transmission operations, reception operations, or both, as described herein. The transceiver 510 may include a modem to modulate and demodulate signals, to provide the modulated signals for transmission (such as via antenna(s) 515, via a wired interface), and to demodulate received signals (such as received via antenna(s) 515, received via a wired interface). The transceiver 510 may be operable to support communication via one or more communication links (such as a communication link 125-b, a backhaul link 132-b, a midhaul link 162-b, fronthaul link 168-b).

The processor 530 may be a general-purpose processing component that supports various operations (such as applications) of the device 505. The memory 525 may be a general-purpose storage component that stores code executable by the processor 530. Such code may include instructions that, when executed by the processor 530, cause the device 505 to perform various functions (such as to support an application of the device 505).

For examples in which the device 505 is a network entity 105 in a disaggregated architecture, one or more components of the device 505 may be located at one or more of a CU 160-b, a DU 165-b, or an RU 170-b, one or more of which may include aspects of the processing system 520, the processor 530, the memory 525, or the transceiver 510. Functions of the device 505 may be performed at different components or an operation may be divided between different components (such as different functions being supported by aspects of the CU 160-b, the DU 165-b, or the RU 170-b, the transceiver 510, the processor 530, the memory 525, the processing system 520, or any combination thereof). For example, the processing system 520 may be a component of one or more of the CU 160-b, the DU 165-b, or the RU 170-b. In some examples, interfaces between components of device 505 (such as CU 160-b, DU 165-b, RU 170-b) may support communication at a protocol layer or between protocol layers of a protocol stack.

In some examples, the processing system 520 may manage aspects of communication with the CN 150-b (such as via a backhaul link 132). For example, the processing system 520 may manage the transfer of data communication for UEs 115 with a gateway of the CN 150-b. In some examples, the processing system 520 may manage communication with one or more other network entities 105 and may include a controller or scheduler for controlling communication with UEs 115 (such as in cooperation with the one or more other network entities 105). In some examples, the processing system 520 may support an interface (such as X2 interface, Xn interface) to provide communication between network entities 105.

The processing system 520 may be an example of a processing system 145. For example, the processing system 520 may include processor circuitry 535 and memory circuitry 540 that stores code, and the processing system 520 may be configured to cause the device 505 to perform operations that support reporting of available data rates for GBR QoS flows. Although the processing system 520 is illustrated as a separate component, which may involve a separate chip, chipset, or other module, in some implementations, one or more functions described with reference to the processing system 520 may be supported by or performed by a transceiver 510, antenna(s) 515, a processor 530, memory 525, or any combination thereof, such that a processing system 520 may include one or more of a transceiver 510, antenna(s) 515, a processor 530, memory 525, or any combination thereof. Further, processor circuitry 535 and memory circuitry 540 each may be implemented at the device 505 in accordance with an aggregated architecture, or the processor circuitry 535 and the memory circuitry 540 may be implemented at one or more of a CU 160-b, a DU 165-b, or an RU 170-b in accordance with a disaggregated architecture.

By including or configuring the processing system 520 for operation in the device 505 as described herein, may support techniques for activating or deactivating reporting of an available uplink data rate, reporting of an available downlink data rate, or reporting of both the uplink data rate and the downlink data rate, as well as the reporting of the uplink data rate, the downlink data rate, or both, which may result in improved communication reliability, reduced latency, improved user experience related to reduced processing, reduced power consumption, more efficient utilization of communication resources, improved coordination between devices, and longer battery life, improved utilization of processing capability, among other advantages.

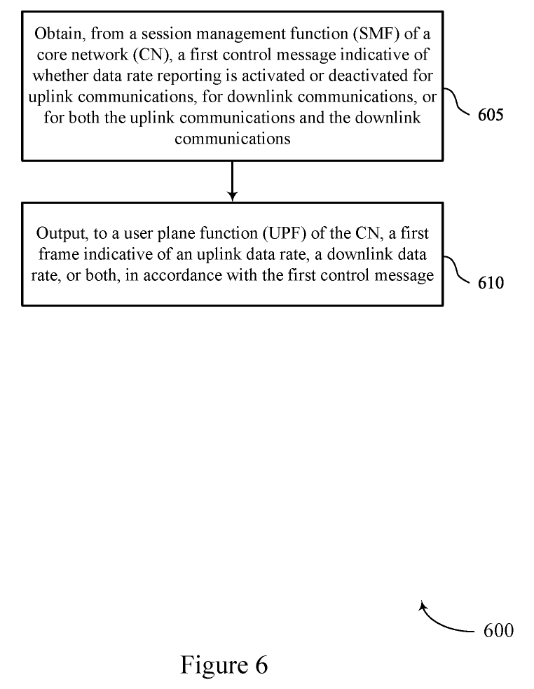

FIG. 6 shows an example of a method 600 that supports reporting of available data rates for GBR QoS flows in accordance with one or more aspects of the present disclosure. Operations of the method 600 may be performed by a network entity 105 or its components (such as using a processing system configured to cause the network entity to perform one or more operations) as described herein.

At 605, the method may include obtaining, from an SMF of a CN, a first control message indicative of whether data rate reporting is activated or deactivated for uplink communications, for downlink communications, or for both the uplink communications and the downlink communications. In some examples, aspects of the operations of 605 may be performed by a configuration component 425.

At 610, the method may include outputting, to a UPF of the CN, a first frame indicative of an uplink data rate, a downlink data rate, or both, in accordance with the first control message. In some examples, aspects of the operations of 610 may be performed by a reporting component 430.

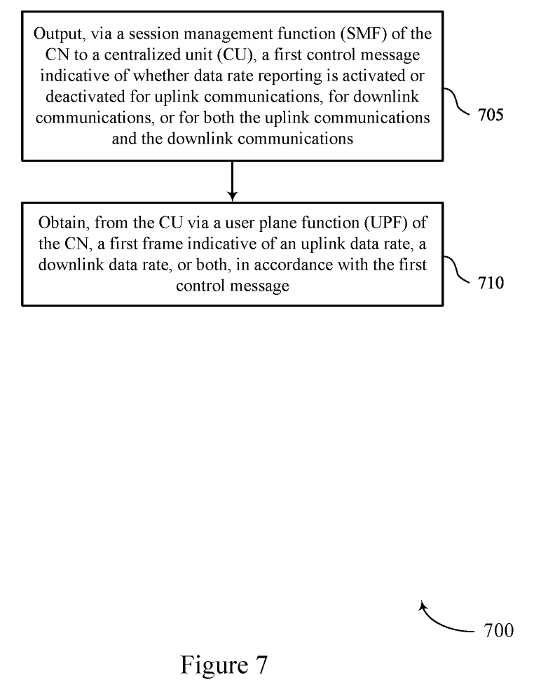

FIG. 7 shows an example of a method 700 that supports reporting of available data rates for GBR QoS flows in accordance with one or more aspects of the present disclosure. Operations of the method 700 may be performed by a network entity 105 or its components (such as using a processing system configured to cause the network entity to perform one or more operations) as described herein.

At 705, the method may include outputting, via an SMF of the CN to a CU, a first control message indicative of whether data rate reporting is activated or deactivated for uplink communications, for downlink communications, or for both the uplink communications and the downlink communications. In some examples, aspects of the operations of 705 may be performed by a configuration component 425.

At 710, the method may include obtaining, from the CU via a UPF of the CN, a first frame indicative of an uplink data rate, a downlink data rate, or both, in accordance with the first control message. In some examples, aspects of the operations of 710 may be performed by a reporting component 430.

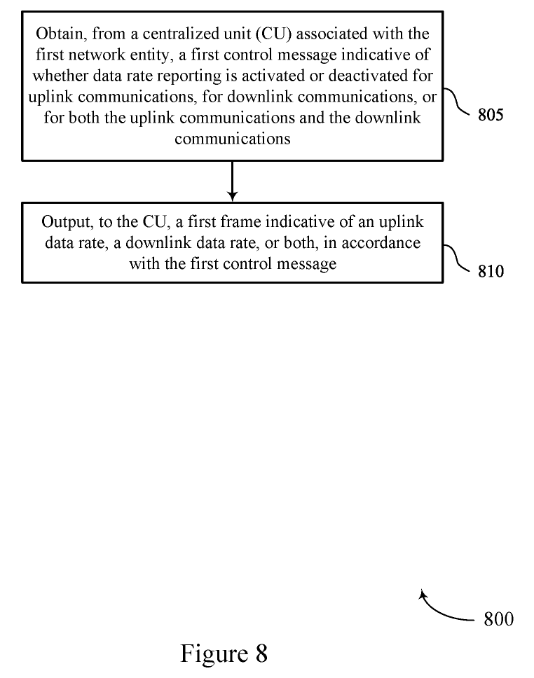

FIG. 8 shows an example of a method 800 that supports reporting of available data rates for GBR QoS flows in accordance with one or more aspects of the present disclosure. Operations of the method 800 may be performed by a network entity 105 or its components (such as using a processing system configured to cause the network entity to perform one or more operations) as described herein.

At 805, the method may include obtaining, from a CU associated with the first network entity, a first control message indicative of whether data rate reporting is activated or deactivated for uplink communications, for downlink communications, or for both the uplink communications and the downlink communications. In some examples, aspects of the operations of 805 may be performed by a configuration component 425.

At 810, the method may include outputting, to the CU, a first frame indicative of an uplink data rate, a downlink data rate, or both, in accordance with the first control message. In some examples, aspects of the operations of 810 may be performed by a reporting component 430.

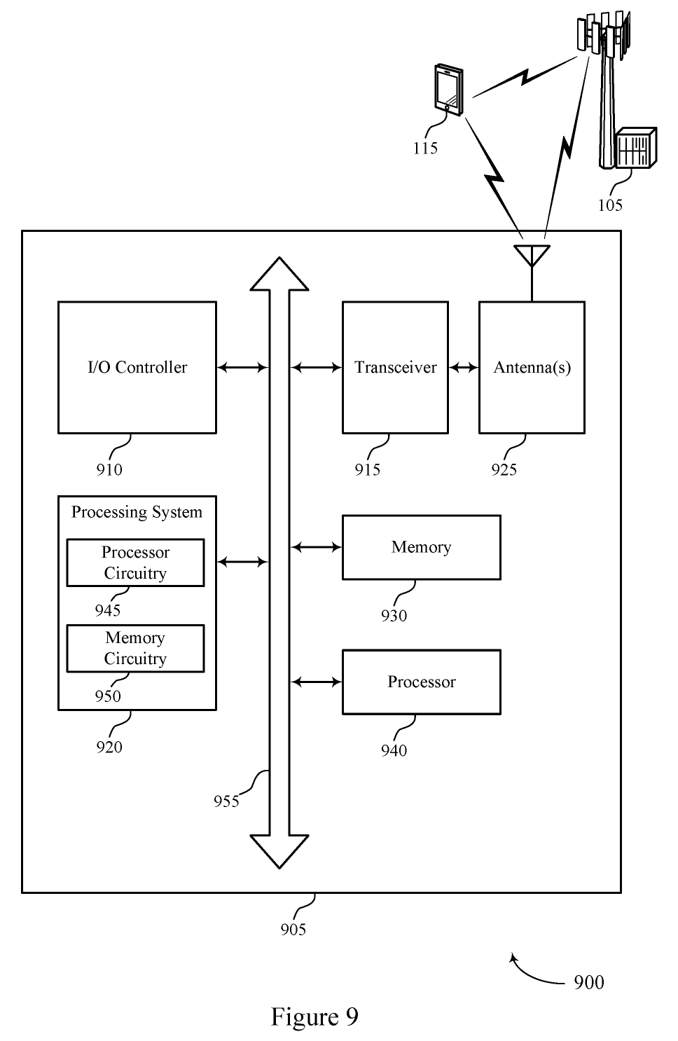

FIG. 9 shows an example of a system 900 including a device 905 supports reporting of available data rates for GBR QoS flows in accordance with one or more aspects of the present disclosure. The device 905 may be an example of or include components of UE 115. The device 905 may communicate (such as wirelessly) with one or more other devices (such as network entities 105, UEs 115). The device 905 may include components for transmitting and receiving communication, which may include a processing system 920, an input/output (I/O) controller, such as an I/O controller 910, a transceiver 915, antenna(s) 925, a memory 930, and a processor 940. Components of the device 905 may be coupled (such as operatively, communicatively, functionally, electronically, electrically, in electronic communication) a bus 955.

The transceiver 915 may support bi-directional communication via antenna(s) 925, and may support transmission operations, reception operations, or both, as described herein. The transceiver 915 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 905). The transceiver 915 may modulate symbols and provide the modulated symbols to antenna(s) 925 for transmission, and demodulate symbols from signals received using antenna(s) 925.

The processor 940 may be a general-purpose processing component that supports various operations (such as applications) of the device 905. The memory 930 may be a general-purpose storage component that stores code executable by the processor 940. Such code may include instructions that, when executed by the processor 940, cause the device 905 to perform various functions (such as to support an application of the device 905). The I/O controller 910 may manage inputs and outputs for the device 905, may manage peripherals not integrated into the device 905, or may represent a physical connection (such as port) to an external peripheral. The processor 940 may interact with a modem, a keyboard, a mouse, a touchscreen, or other device (such as via I/O controller 910). In some implementations, a user may interact with the device 905 via the I/O controller 910 or via hardware components controlled by the I/O controller 910.

The processing system 920 may be an example of a processing system 140. For example, the processing system 920 may include processor circuitry 945 and memory circuitry 950 that stores code, and may be configured to cause the device 905 to perform operations that support power control for physical random access channel order. Although the processing system 920 is illustrated as a separate component, which may involve a separate chip, chipset, or other module, in some implementations, one or more functions described with reference to the processing system 920 may be supported by or performed by a transceiver 915, antenna(s) 925, a processor 940, memory 930, or any combination thereof, such that a processing system 920 may include one or more of a transceiver 915, antenna(s) 925, a processor 940, memory 930, or any combination thereof.

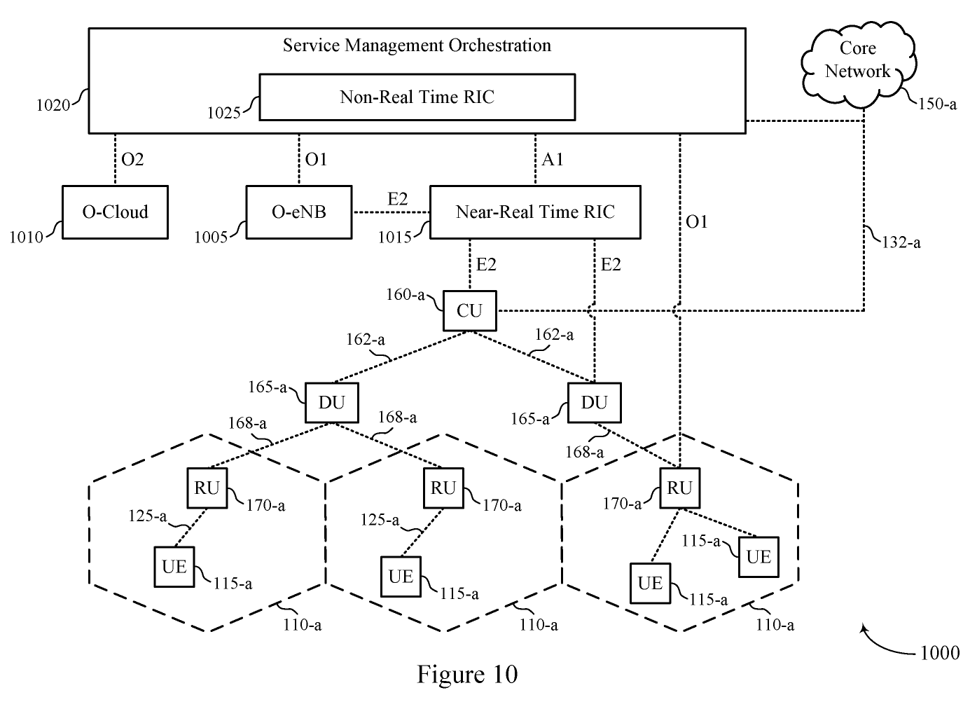

FIG. 10 shows an example of a network architecture 1000 (e.g., a disaggregated base station architecture, a disaggregated RAN architecture) that supports power control for physical random access channel order in accordance with one or more aspects of the present disclosure. The network architecture 1000 (such as a network architecture, a disaggregated base station architecture, a disaggregated RAN architecture) illustrates an example for implementing one or more aspects of a communication system 100 (such as a RAN 120), and may include one or more of a CU 160-a, a DU 165-a, and an RU 170-a.

In the example of network architecture 1000, a CU 160-a may communicate directly with a core network 150-a via a backhaul link 132-a, or indirectly with the core network 150-a through one or more disaggregated network entities 105. A CU 160-a may be connected with a DU 165-a via a midhaul link 162-a (such as an F1, F1c, or F1u interface), and a DU 165-a may be connected with an RU 170-a via fronthaul communication link 168-a (such as an open fronthaul (FH) interface). The RUs 170-a may be associated with respective coverage areas 110-a and may communicate with UEs 115-a via one or more communication links 125-a. A UE 115-a may be served by one or more of an RU 170-a, and multiples of an RU 170-a serving a UE 115-a may be associated with one or more of a DU 165-a.

A split of functionality between one or more of a CU 160-a, a DU 165-a, and an RU 170-a is flexible and may support different functionalities depending on which functions (such as network layer functions, protocol layer functions, baseband functions, RF functions, or combination thereof) are performed at the various entities. For example, a functional split of a protocol stack may be employed such that a CU 160-a, a DU 165-a, and an RU 170-a may each support one or more different layers of the protocol stack. Additionally, or alternatively, a functional split of a protocol stack may be within a protocol layer, such that some functions for a protocol layer are performed by one of a CU 160-a, a DU 165-a, or an RU 170-a, and some other functions of the protocol layer are performed by a different one of the CU 160-a, the DU 165-a, or the RU 170-a.

A CU 160-a may host upper protocol layer (such as layer 3 (L3), layer 2 (L2)) functionality and signaling (such as RRC, SDAP, PDCP). A CU 160-a may be functionally split into CU control plane (CU-CP) and CU user plane (CU-UP) functions. A CU 160-a may be logically split into one or more CU-UP units and one or more CU-CP units. A CU-UP unit may communicate bidirectionally with the CU-CP unit via an interface (such as an E1 interface). A CU 160-a may be connected with one or more of a DU 165-a, one or more of an RU 170-a, or a combination thereof. DUs 165-a, RUs 170-a, or both may host lower protocol layers, which may include layer 1 (L1) (such as PHY layer) or L2 (such as RLC layer, MAC layer) functionality and signaling, and each may be at least partially controlled by a CU 160-a. A DU 165-a may support one or multiple different cells (such as via one or more of an RU 170-a).

The network architecture 1000 may include a Service Management and Orchestration (SMO) framework (such as implementing an SMO 1020) configured to support RAN deployment and provisioning of non-virtualized and virtualized network entities 105. The network architecture 1000 also may include a RAN Intelligent Controller (RIC), types of which may include Near-Real Time (RT) or Non-RT. In some cases, a network entity 105 (such as a CU 160-a, a DU 165-a) may communicate with a Near-RT RIC 1015 via an E2 link, or a non-RT RIC 1025 associated with SMO 1020, or both. An RU 170-a also may be referred to as a radio head, a smart radio head, a remote radio head (RRH), a remote radio unit (RRU), or a transmission/reception point (TRP). One or more components of a disaggregated RAN architecture may be co-located, or may be located in distributed (such as separate physical) locations. One or more network entities 105 of a disaggregated RAN architecture may be implemented as virtual units (such as a virtual CU (VCU), a virtual DU (VDU), a virtual RU (VRU)) and provide network function virtualization, which may be supported by an open-cloud (O-Cloud) platform (such as an O-Cloud 1010). For example, functionality of a network entity 105 may be implemented in an O-eNB 1005.

The following provides an overview of examples of the present disclosure:

Aspect 1: A method for wireless communications at a CU associated with a first network entity, comprising: obtaining, from an SMF of a CN, a first control message indicative of whether data rate reporting is activated or deactivated for uplink communications, for downlink communications, or for both the uplink communications and the downlink communications; and outputting, to a UPF of the CN, a first frame indicative of an uplink data rate, a downlink data rate, or both, in accordance with the first control message.

Aspect 2: The method of aspect 1, wherein the first frame comprises a first information element indicative of whether data reporting is activated or deactivated for the uplink communications, a second information element indicative of whether data rate reporting is activated or deactivated for the downlink communications, or both.

Aspect 3: The method of aspect 2, wherein each of the first information element and the second information element comprise one or more bits.

Aspect 4: The method of aspect 3, wherein a first value of the one or more bits indicates the data rate reporting is deactivated.

Aspect 5: The method of any of aspects 3 through 4, wherein a second value of the one or more bits indicates the data rate reporting is activated.

Aspect 6: The method of any of aspects 2 through 5, wherein an absence of the first information element in the first control message indicates no change to the data rate reporting for the uplink communications.

Aspect 7: The method of any of aspects 2 through 6, wherein an absence of the second information element in the first control message indicates no change to the data rate reporting for the downlink communications.

Aspect 8: The method of any of aspects 1 through 7, wherein the first control message comprises a PDU session resource setup request, a PDU session resource modify request, a path switch request acknowledgment, or any combination thereof.

Aspect 9: The method of aspect 8, wherein the first control message comprises GBR QoS information that indicates whether the data rate reporting is activated or deactivated for the uplink communications, for the downlink communications, or for both the uplink communications and the downlink communications.

Aspect 10: The method of any of aspects 1 through 9, further comprising: communicating a second control message indicative of whether the data rate reporting is activated or deactivated for the uplink communications, for the downlink communications, or for both the uplink communications and the downlink communications, based at least in part on reception of the first control message.

Aspect 11: The method of aspect 10, wherein the CU is associated with a CP and a UP, and the second control message is communicated from the CP to the UP.

Aspect 12: The method of any of aspects 10 through 11, wherein the second control message comprises a bearer context setup request, a bearer context modification request, or both.

Aspect 13: The method of aspect 12, wherein the second control message comprises GBR QoS information that indicates whether the data rate reporting is activated or deactivated for the uplink communications, for the downlink communications, or for both the uplink communications and the downlink communications.

Aspect 14: The method of any of aspects 10 through 13, wherein the uplink data rate, the downlink data rate, or both, are measured by a UP at the CU.

Aspect 15: The method of any of aspects 1 through 14, wherein the CU is a first CU, the method further comprising: outputting, to a second CU associated with a second network entity, a second control message indicative of whether the data rate reporting is activated or deactivated for the uplink communications, for the downlink communications, or for both the uplink communications and the downlink communications, based at least in part on reception of the first control message; and

Aspect 16: The method of aspect 15, wherein the second control message comprises a handover request, a retrieve UE context response, a secondary node addition request, a secondary node modification request, or any combination thereof.

Aspect 17: The method of aspect 16, wherein the second control message comprises GBR QoS information that indicates whether the data rate reporting is activated or deactivated for the uplink communications, for the downlink communications, or for both the uplink communications and the downlink communications.

Aspect 18: The method of any of aspects 15 through 17, wherein the first network entity is a master network entity, and the second network entity is a secondary network entity.

Aspect 19: The method of any of aspects 15 through 18, further comprising: obtaining, from the second CU associated with the second network entity, a second frame indicative of the uplink data rate, the downlink data rate, or both, in accordance with the second control message, wherein transmission of the first frame is based at least in part on reception of the second frame.

Aspect 20: The method of aspect 19, wherein the second frame comprises a first information element indicative of the uplink data rate, a second information element indicative of the downlink data rate, or both.

Aspect 21: The method of aspect 20, wherein each of the first information element and the second information element comprise a bit rate information element indicative of a respective data rate.

Aspect 22: The method of aspect 21, wherein the bit rate information element is associated with a fixed length.

Aspect 23: The method of any of aspects 20 through 22, wherein each of the first information element and the second information element comprise a bit rate information element indicative of a respective data rate.

Aspect 24: The method of aspect 23, wherein the bit rate information element is associated with a variable length.

Aspect 25: The method of aspect 24, wherein the second frame comprises a third information element indicative of a length of the first information element indicative of the uplink data rate.

Aspect 26: The method of any of aspects 24 through 25, wherein the second frame comprises a fourth information element indicative of a length of the second information element indicative of the downlink data rate.

Aspect 27: The method of any of aspects 20 through 26, wherein each of the first information element and the second information element comprise a bit rate information element indicative of a respective data rate relative to a respective threshold data rate.

Aspect 28: The method of any of aspects 19 through 27, wherein the second network entity hosts a packet data convergence protocol (PDCP) entity, and the second frame comprises an assistance information data frame that indicates the uplink data rate, the downlink data rate, or both.

Aspect 29: The method of any of aspects 19 through 28, wherein the second frame comprises a first indicator that signals a presence of the uplink data rate in the second frame, a second indicator that signals a presence of the downlink data rate in the second frame, or both.

Aspect 30: The method of any of aspects 1 through 29, further comprising: outputting, to a DU associated with the first network entity, a second control message indicative of whether the data rate reporting is activated or deactivated for the uplink communications, for the downlink communications, or for both the uplink communications and the downlink communications, based at least in part on reception of the first control message; and obtaining, from the DU, a second frame indicative of the uplink data rate, the downlink data rate, or both, in accordance with the second control message, wherein transmission of the first frame is based at least in part on reception of the second frame.

Aspect 31: The method of aspect 30, wherein the second control message comprises a UE context setup request, a UE context modification request, or both.

Aspect 32: The method of aspect 31, wherein the second control message comprises GBR QoS information that indicates whether the data rate reporting is activated or deactivated for the uplink communications, for the downlink communications, or for both the uplink communications and the downlink communications.

Aspect 33: The method of any of aspects 30 through 32, wherein the uplink data rate, the downlink data rate, or both, are measured by the DU.

Aspect 34: The method of any of aspects 1 through 33, wherein the first frame comprises a first information element indicative of the uplink data rate, a second information element indicative of the downlink data rate, or both.

Aspect 35: The method of aspect 34, wherein each of the first information element and the second information element comprise a bit rate information element indicative of a respective data rate.

Aspect 36: The method of aspect 35, wherein the bit rate information element is associated with a fixed length.

Aspect 37: The method of any of aspects 34 through 36, wherein each of the first information element and the second information element comprise a bit rate information element indicative of a respective data rate.

Aspect 38: The method of aspect 37, wherein the bit rate information element is associated with a variable length.

Aspect 39: The method of aspect 38, wherein the first frame comprises a third information element indicative of a length of the first information element indicative of the uplink data rate.

Aspect 40: The method of any of aspects 38 through 39, wherein the first frame comprises a fourth information element indicative of a length of the second information element indicative of the downlink data rate.

Aspect 41: The method of any of aspects 34 through 40, wherein each of the first information element and the second information element comprise a bit rate information element indicative of a respective data rate relative to a respective threshold data rate.

Aspect 42: The method of any of aspects 1 through 41, wherein the first frame comprises an uplink PDU session information frame that indicates the uplink data rate, the downlink data rate, or both.

Aspect 43: The method of any of aspects 1 through 42, wherein the first frame comprises a first indicator that signals a presence of the uplink data rate in the first frame, a second indicator that signals a presence of the downlink data rate in the first frame, or both.

Aspect 44: The method of any of aspects 1 through 43, wherein the first frame comprises a first information element indicative of whether data reporting is activated or deactivated for the uplink communications, indicative of whether data rate reporting is activated or deactivated for the downlink communications, or both.

Aspect 45: The method of aspect 44, wherein the first information element comprises one or more bits, wherein a first value of the one or more bits indicates the data rate reporting is deactivated or a second value of the one or more bits indicates the data rate reporting is activated.

Aspect 46: The method of any of aspects 44 and 45, wherein an absence of the first information element in the first control message indicates no change to the data rate reporting for the uplink communications, the downlink communications, or both.

Aspect 47: The method of any of aspects 1 through 46, further comprising: communicating a second control message indicative of whether the data rate reporting is activated or deactivated for the uplink communications, for the downlink communications, or for both the uplink communications and the downlink communications, based at least in part on reception of the first control message.

Aspect 48: The method of aspect 47, wherein the second control message comprises one of a bearer context setup request or a bearer context modification request.

Aspect 49: The method of any of aspects 1 through 48, wherein the CU is a first CU, the method further comprising: outputting, to a second CU associated with a second network entity, a second control message indicative of whether the data rate reporting is activated or deactivated for the uplink communications, for the downlink communications, or for both the uplink communications and the downlink communications, based at least in part on reception of the first control message.

Aspect 50: The method of aspect 49, further comprising: obtaining, from the second CU associated with the second network entity, a second frame indicative of the uplink data rate, the downlink data rate, or both, in accordance with the second control message, wherein transmission of the first frame is based at least in part on reception of the second frame.

Aspect 51: The method of aspect 50, wherein the second frame comprises a first information element comprising a first bit information element indicative of the uplink data rate, a second information element comprising a second bit information element indicative of the downlink data rate, or both.

Aspect 52: The method of any of aspects 1 through 51, wherein the first frame comprises a first information element comprising a first bit rate information element indicative of the uplink data rate, a second information element comprising a second bit rate information element indicative of the downlink data rate, or both.

Aspect 53: A method for wireless communications at a CN, comprising: outputting, via an SMF of the CN to a CU, a first control message indicative of whether data rate reporting is activated or deactivated for uplink communications, for downlink communications, or for both the uplink communications and the downlink communications; and obtaining, from the CU via a UPF of the CN, a first frame indicative of an uplink data rate, a downlink data rate, or both, in accordance with the first control message.

Aspect 54: The method of aspect 53, wherein the first control message comprises a first information element indicative of whether data reporting is activated or deactivated for the uplink communications, a second information element indicative of whether data rate reporting is activated or deactivated for the downlink communications, or both.

Aspect 55: The method of aspect 54, wherein each of the first information element and the second information element comprise one or more bits.

Aspect 56: The method of aspect 55, wherein a first value of the one or more bits indicates the data rate reporting is deactivated.

Aspect 57: The method of any of aspects 55 through 56, wherein a second value of the one or more bits indicates the data rate reporting is activated.

Aspect 58: The method of any of aspects 54 through 57, wherein an absence of the first information element in the first control message indicates no change to the data rate reporting for the uplink communications.

Aspect 59: The method of any of aspects 54 through 58, wherein an absence of the second information element in the first control message indicates no change to the data rate reporting for the downlink communications.

Aspect 60: The method of any of aspects 53 through 59, wherein the first control message comprises a PDU session resource setup request, a PDU session resource modify request, a path switch request acknowledgment, or any combination thereof.

Aspect 61: The method of aspect 60, wherein the first control message comprises GBR QoS information that indicates whether the data rate reporting is activated or deactivated for the uplink communications, for the downlink communications, or for both the uplink communications and the downlink communications.

Aspect 62: The method of any of aspects 53 through 61, wherein the first frame comprises a first information element indicative of the uplink data rate, a second information element indicative of the downlink data rate, or both.

Aspect 63: The method of aspect 62, wherein each of the first information element and the second information element comprise a bit rate information element indicative of a respective data rate.

Aspect 64: The method of aspect 63, wherein the bit rate information element is associated with a fixed length.

Aspect 65: The method of any of aspects 62 through 64, wherein each of the first information element and the second information element comprise a bit rate information element indicative of a respective data rate.

Aspect 66: The method of aspect 65, wherein the bit rate information element is associated with a variable length.

Aspect 67: The method of aspect 66, wherein the first frame comprises a third information element indicative of a length of the first information element indicative of the uplink data rate.

Aspect 68: The method of any of aspects 66 through 67, wherein the first frame comprises a fourth information element indicative of a length of the second information element indicative of the downlink data rate.

Aspect 69: The method of any of aspects 62 through 68, wherein each of the first information element and the second information element comprise a bit rate information element indicative of a respective data rate relative to a respective threshold data rate.

Aspect 70: The method of any of aspects 53 through 69, wherein the first frame comprises an uplink PDU session information frame that indicates the uplink data rate, the downlink data rate, or both.

Aspect 71: The method of any of aspects 53 through 70, wherein the first frame comprises a first indicator that signals a presence of the uplink data rate in the first frame, a second indicator that signals a presence of the downlink data rate in the first frame, or both.

Aspect 72: A method for wireless communications at a DU associated with a first network entity, comprising: obtaining, from a CU associated with the first network entity, a first control message indicative of whether data rate reporting is activated or deactivated for uplink communications, for downlink communications, or for both the uplink communications and the downlink communications; and outputting, to the CU, a first frame indicative of an uplink data rate, a downlink data rate, or both, in accordance with the first control message.

Aspect 73: The method of aspect 72, wherein the first control message comprises a UE context setup request, a UE context modification request, or both.

Aspect 74: The method of aspect 73, wherein the first control message comprises GBR QoS information that indicates whether the data rate reporting is activated or deactivated for the uplink communications, for the downlink communications, or for both the uplink communications and the downlink communications.

Aspect 75: The method of any of aspects 72 through 74, wherein the uplink data rate, the downlink data rate, or both, are measured by the DU.

Aspect 76: A CU associated with a first network entity for wireless communications, comprising a processing system that includes processor circuitry and memory circuitry that stores code, the processing system configured to cause the CU associated with a first network entity to perform a method of any of aspects 1 through 43.

Aspect 77: A CU associated with a first network entity for wireless communications, comprising at least one means for performing a method of any of aspects 1 through 43.

Aspect 78: A non-transitory computer-readable medium storing code for wireless communications, the code comprising instructions executable by one or more processors to perform a method of any of aspects 1 through 43.

Aspect 79: A CN for wireless communications, comprising a processing system that includes processor circuitry and memory circuitry that stores code, the processing system configured to cause the CN to perform a method of any of aspects 53 through 71.

Aspect 80: A CN for wireless communications, comprising at least one means for performing a method of any of aspects 53 through 71.

Aspect 81: A non-transitory computer-readable medium storing code for wireless communications, the code comprising instructions executable by one or more processors to perform a method of any of aspects 53 through 71.

Aspect 82: A DU associated with a first network entity for wireless communications, comprising a processing system that includes processor circuitry and memory circuitry that stores code, the processing system configured to cause the DU associated with a first network entity to perform a method of any of aspects 72 through 75.

Aspect 83: A DU associated with a first network entity for wireless communications, comprising at least one means for performing a method of any of aspects 72 through 75.

Aspect 84: A non-transitory computer-readable medium storing code for wireless communications, the code comprising instructions executable by one or more processors to perform a method of any of aspects 72 through 75.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a centralized unit (CU) associated with a first network entity, comprising:
one or more memories storing processor-executable code; and
one or more processors coupled with the one or more memories and configured to cause the CU to:
obtain, from a session management function (SMF) of a core network (CN), a first control message indicative of whether data rate reporting is activated or deactivated for uplink communications, for downlink communications, or for both the uplink communications and the downlink communications; and
output, to a user plane function (UPF) of the CN, a frame indicative of an uplink data rate, a downlink data rate, or both, in accordance with the first control message.

2. The apparatus of claim 1, wherein the first control message comprises guaranteed bit rate (GBR) quality of service (QoS) information that indicates whether the data rate reporting is activated or deactivated for the uplink communications, for the downlink communications, or for both the uplink communications and the downlink communications.

3. The apparatus of claim 1, wherein the frame comprises a first information element indicative of whether data reporting is activated or deactivated for the uplink communications, indicative of whether data rate reporting is activated or deactivated for the downlink communications, or both.

4. The apparatus of claim 3, wherein the first information element comprises one or more bits, wherein a first value of the one or more bits indicates the data rate reporting is deactivated, or a second value of the one or more bits indicates the data rate reporting is activated.

5. The apparatus of claim 3, wherein an absence of the first information element in the first control message indicates no change to the data rate reporting for the uplink communications, the downlink communications, or both.

6. The apparatus of claim 1, wherein the first control message comprises a packet data unit (PDU) session resource setup request, a PDU session resource modify request, a path switch request acknowledgment, or any combination thereof.

7. The apparatus of claim 1, wherein the one or more processors are further configured to cause the CU to:
communicate a second control message indicative of whether the data rate reporting is activated or deactivated for the uplink communications, for the downlink communications, or for both the uplink communications and the downlink communications, based at least in part on reception of the first control message.

8. The apparatus of claim 7, wherein the CU is associated with a control plane (CP) and a user plane (UP), and wherein the second control message is communicated from the CP to the UP.

9. The apparatus of claim 7, wherein the second control message comprises one of a bearer context setup request or a bearer context modification request.

10. The apparatus of claim 1, wherein the CU is a first CU, and the one or more processors are further configured to cause the CU to:
output, to a second CU associated with a second network entity, a second control message indicative of whether the data rate reporting is activated or deactivated for the uplink communications, for the downlink communications, or for both the uplink communications and the downlink communications, based at least in part on reception of the first control message.

11. The apparatus of claim 10, wherein the second control message comprises a handover request, a retrieve user equipment (UE) context response, a secondary node addition request, a secondary node modification request, or any combination thereof.

12. The apparatus of claim 10, wherein the one or more processors are further configured to cause the CU to:
obtain, from the second CU associated with the second network entity, a second frame indicative of the uplink data rate, the downlink data rate, or both, in accordance with the second control message, wherein transmission of the frame is based at least in part on reception of the second frame.

13. The apparatus of claim 12, wherein the second frame comprises a first information element comprising a first bit information element indicative of the uplink data rate, a second information element comprising a second bit information element indicative of the downlink data rate, or both.

14. The apparatus of claim 12, wherein the second network entity hosts a packet data convergence protocol (PDCP) entity, and wherein the second frame comprises an assistance information data frame that indicates the uplink data rate, the downlink data rate, or both.

15. The apparatus of claim 1, wherein the one or more processors are further configured to cause the CU to:
output, to a distributed unit (DU) associated with the first network entity, a second control message indicative of whether the data rate reporting is activated or deactivated for the uplink communications, for the downlink communications, or for both the uplink communications and the downlink communications, based at least in part on reception of the first control message; and
obtain, from the DU, a second frame indicative of the uplink data rate, the downlink data rate, or both, in accordance with the second control message, wherein transmission of the frame is based at least in part on reception of the second frame.

16. The apparatus of claim 1, wherein the frame comprises a first information element comprising a first bit rate information element indicative of the uplink data rate, a second information element comprising a second bit rate information element indicative of the downlink data rate, or both.

17. The apparatus of claim 1, wherein the frame comprises an uplink PDU session information frame that indicates the uplink data rate, the downlink data rate, or both.

18. The apparatus of claim 1, wherein the frame comprises a first indicator that signals a presence of the uplink data rate in the frame, a second indicator that signals a presence of the downlink data rate in the frame, or both.

19. An apparatus for wireless communication at a core network (CN), comprising:
one or more memories storing processor-executable code; and
one or more processors coupled with the one or more memories and configured to cause the CN to:
output, via a session management function (SMF) of the CN to a centralized unit (CU), a first control message indicative of whether data rate reporting is activated or deactivated for uplink communications, for downlink communications, or for both the uplink communications and the downlink communications; and
obtain, from the CU via a user plane function (UPF) of the CN, a frame indicative of an uplink data rate, a downlink data rate, or both, in accordance with the first control message.

20. An apparatus for wireless communication at a distributed unit (DU) associated with a first network entity, comprising:
one or more memories storing processor-executable code; and
one or more processors coupled with the one or more memories and configured to cause the DU to:
obtain, from a centralized unit (CU) associated with the first network entity, a first control message indicative of whether data rate reporting is activated or deactivated for uplink communications, for downlink communications, or for both the uplink communications and the downlink communications; and
output, to the CU, a frame indicative of an uplink data rate, a downlink data rate, or both, in accordance with the first control message.
